(19) United States
(12) Patent Application Publication
(10) Pub. No.: US 2009/0248516 A1
(43) Pub. Date: Oct. 1, 2009

(54) Method for annotating web content in real-time

(76) Inventor: Evan N. Gross, Hillsboro Beach, FL (US)

Correspondence Address: MALLOY & MALLOY, P.A., Historic Coral Way, 2800 S.W. Third Avenue, Miami, FL, 33129, US

(21) Appl. No.: 12/079,400

(22) Filed: Mar. 26, 2008

(51) Int. Cl. G06F 3/048; G06Q 30/00

(52) U.S. Cl. 705/14; 715/738; 715/719

(57) ABSTRACT

A computer-related method is presented for annotating web content in real-time via a client interface, the method including selecting at least one portion of a requested and/or displayed web page. The computer-related method further includes creating and embedding at least one annotation, in real-time at the selected portion of the web page. Subsequently, the web page(s) and/or annotation(s) may be saved or otherwise communicated to an electronic storage medium and accessed, viewed, or shared.

### BACKGROUND OF THE INVENTION

1. Field of the Invention

The present specification is generally directed to a computer-related method for annotating web content in real-time via a client interface disposed in a communicative relation with an interactive computer network, such as, for example, the World Wide Web.

2. Description of the Related Art

Today's consumer, whether it be an individual person, an established business, or a large corporation, often seeks advice in the form of comments, past experiences, opinions, etc. from other consumers prior to effectuating a purchase of any one or more products or services. In particular, online advocates, consumer-generated media, and word of mouth tend to have a greater impact on a consumer's purchasing habits than traditional forms of marketing, advertising, or other forms of media.

In addition, consumers tend to associate a high risk of failure and/or fraud with transactions effectuated via the Internet, or other forms of electronic-commerce (“e-commerce”). Moreover, this perception is based at least in part upon “information asymmetry” which tends to flood the e-commerce market. In particular, “information asymmetry” is present when one party involved in a transaction is equipped with more or better information than the other party. Oftentimes consumers who conduct transactions via the Internet or other online source have the perception that sellers are equipped with more information about the product than the purchasers, thus creating “information asymmetry” for various online transactions. It is for this reason that many consumers utilize the World Wide Web to gather information about a product and/or service, however, prefer that the transaction is effectuated in person.

Although the Internet may be utilized to gather information pertaining to products, services, traveling, vacation spots, web pages, or other content, vast amounts of the information originates from unknown sources, may be falsified, and/or is at least partially unreliable. For instance, one or more reviews, opinions, or comments regarding a company's product for sale may originate from the actual company itself, whereas the review may falsely indicate that it is created by a valued customer who has tested, used, and appreciates the product and/or service. On the other hand, however, the review, comment, or opinion may originate from a competitor who never tried, tested, or used the product or service. Accordingly, the competitor or other individual may post a negative review or comment related to the particular product and/or service in spite of competition.

It is for these reasons and many others that there is a current need in the art for a method to dynamically provide, in real-time, credible, relevant, and accurate transactional guidance and/or information to a user, such as a consumer or purchaser, via an interactive computer network, so as to increase the reliability and credibility of information gathering or purchasing via the Internet, and/or other e-commerce features and benefits. As such, it would be beneficial if at least one method of the present specification allows consumers and other individuals, businesses, partnerships, and/or corporations to unite through an online interactive social network and/or commerce environment. Moreover, as a user navigates the World Wide Web, whether it be in search for information and/or to purchase a product or service, it would be beneficial to dynamically provide, in real-time, reviews, opinions, comments, videos, photographs, or other objects at least partially related to the currently viewed web page, wherein the various objects were created by a credible and reliable source, such as a member within the user's network of trusted individuals. In addition, it would be advantageous if the present specification permits users, members, or residents of the interactive social network to be active in open dialogue of problems, solutions, advice, comments, reviews, and other annotations relating to various products, services, entities, web pages, articles, etc.

Furthermore, as an individual or other user accesses, reads, or otherwise views web content, including, for example, one or more web page(s), articles, videos, photographs, animations, etc., the user may want to save the web page or other web content, highlight, create one or more comments, or other annotations regarding the web content, and/or send the web page and the corresponding annotation(s) to one or more individuals. As such, under current technology, a user may typically save the web content, for example by storing the web content to a hard drive or other electronic storage medium and/or e-mail the web content to himself/herself or any other individual. In such an instance, however, the user and/or recipient of the web content may be confused or unaware as to why the web content was saved and/or communicated. For example, was there a specific term, phrase, comment, etc. or was there a particular portion of the web page in which the user wanted to reference, highlight, or comment on. As such, subsequent to downloading, saving, and/or e-mailing the web page or other web content, a user may comment or summarize the web page or other web content in general, for example, by adding text before or after the article, or a user may place specific comments or annotations on or within the web page.

Accordingly, there is a current need in the art for a computer-related method for annotating web content, in real-time, for example, as the user accesses or otherwise views the web content via a web browser or other like program or application. In such an instance, at least one proposed method of the present specification includes selecting at least one portion of the web content and embedding, in real-time, at least one annotation at the selected portion. Thereafter, the user may, if desired, save the web content and/or the annotations to an electronic storage medium, such as, for example, the user's computer hard drive, flash drive, CD-ROM, DVD-ROM, etc. In addition, however, the web content and/or annotation(s) may be communicated to a network and/or annotation server which is linked to the interactive social network. Accordingly, other members of the interactive social network, such as those in the user's personal or common network, may access the web content and/or annotation(s). The members may then create their own annotation(s) within the web content, thereby creating a working document thereof.

### SUMMARY OF THE INVENTION

The present specification is generally directed to a computer-related method for dynamically providing credible, relevant, and accurate guidance to a user via an interactive computer network, such as, for example, the World Wide Web. In particular, at least one embodiment of the present specification includes an interactive social network structured to unite, relate, link, or otherwise interconnect one or more members thereof in an interactive and/or social environment. Moreover, as will be explained in greater detail below, the interactive social network of at least one embodiment is further structured such that each member controls, configures, and manages a multi-tiered network system which allows the various members thereof to be interconnected with other members in any one or a plurality of networks or manners. This enables the user to have control of whom he/she believes to be a credible and/or reliable source. For example, any two or more members of the interactive social network may be interconnected with one another by virtue of belonging to or being associated with one or more similar affinities or groups, such as a hobby, geographical location, interest, area, or zone. In addition, as will be discussed in greater detail below, the various members of the interactive social network of at least one embodiment of the present specification may be related to or otherwise interconnected with one another by virtue of being specifically invited into a network relationship. In addition, the various relationship structures may be stacked, aggregated, or otherwise combined in any one or a plurality of manners so as to create networks within networks.

Furthermore, each member may post or develop various comments, opinions, reviews, or annotations, for example, on or within another member's multi-tiered network system. As such, when a member searches or otherwise navigates the World Wide Web, such as via a web browser, the method of at least one embodiment of the present specification evaluates and/or identifies the requested web content, and searches for network objects, such as the comments, opinions, reviews, annotations, etc., which are affiliated with or otherwise at least partially related to the web content. In addition, as the user navigates the World Wide Web by virtue of entering web addresses or search queries in a search engine, the method of at least one embodiment of the present invention dynamically filters, in real time, the various network objects and/or affiliated network objects based upon a calculated network relationship status between the particular user and the author or creator of the network objects(s), such as the member or other individual who posted or developed the network object(s). In particular, depending upon a network relationship criteria, such as, for example, a maximum degree of separation, the method filters the network object(s) and displays only those which satisfy the network relationship criteria. This assures the user that the comment(s), review(s), opinion(s), or other network objects originate from a credible source and may be relied upon.

Additionally, the present specification includes a computer-related method for annotating web content in real-time via an interactive computer network. In particular, while simultaneously viewing web content requested and displayed via an interactive computer network, such as the World Wide Web, a user may select a portion of the web content, create an annotation, and embed the annotation, in real-rime, within the selected portion of the web content.

The web content and/or annotation(s) may then be saved to an electronic storage medium and viewed at a later time and/or shared with other individuals. The other individuals may create their own annotation(s) within the web content, which can also be shared. This, in essence, creates a working document having various annotations which may include reviews, opinions, comments, pictures, photographs, videos, etc. allowing users, and other members to gather information, share thoughts, and equalize the “information asymmetry” which many online and e-commerce consumers believe is present in electronic transactions.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of one or more components of at least one embodiment disclosed in the present specification.

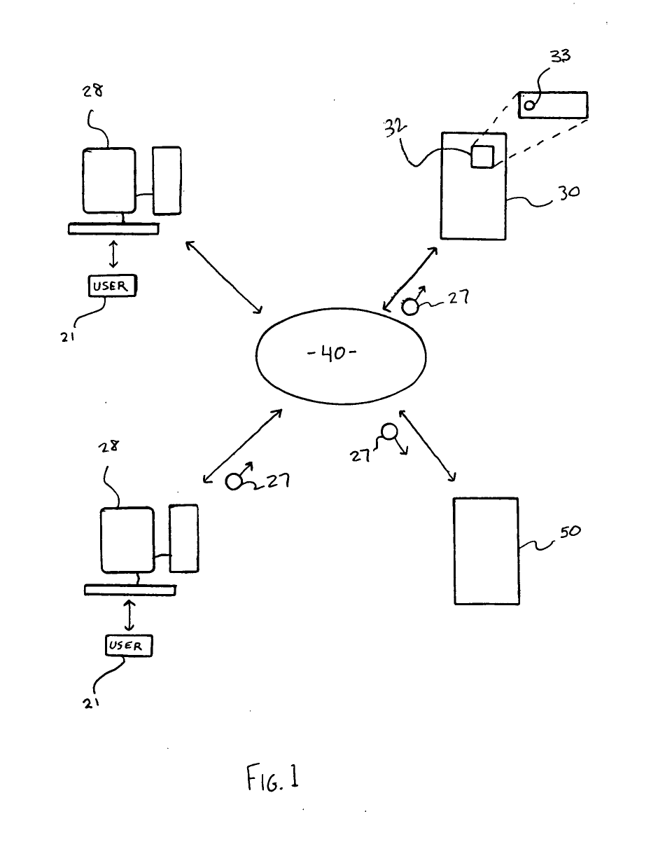

FIG. 2 is a schematic representation of at least one illustrative embodiment of the interconnection of two or more members of the interactive social network by virtue of the multi-tiered network system disclosed in the present specification.

FIG. 3 is yet another schematic representation of at least one illustrative embodiment of the interconnection of two or more members of the interactive social network disclosed in the present specification.

FIG. 4 is a schematic representation of the interaction of members of the interactive social network with other Internet site(s), web content, web page(s), etc. as disclosed in the present specification.

FIG. 5 is a high-level flow chart illustrating at least one embodiment of the method for dynamically providing credible, relevant, and accurate guidance to a user via an interactive computer network as disclosed in the present specification.

FIG. 6 is a schematic representation of at least one illustrative embodiment of affiliated network object(s), web content, and an interactive communication module.

FIG. 7 is yet another schematic representation of at least one illustrative embodiment of the present specification.

FIG. 8 is a chart illustrating at least one embodiment of the plurality of distribution channels within which a product may be offered for sale as disclosed herein.

FIG. 9 is a high level flow chart illustrating at least one embodiment of the computer-related method for dynamically annotating web content in real time via a client interface as disclosed in the present specification.

FIG. 10 is a schematic representation of at least one embodiment illustrating annotations embedded within a web page as disclosed in the present specification.

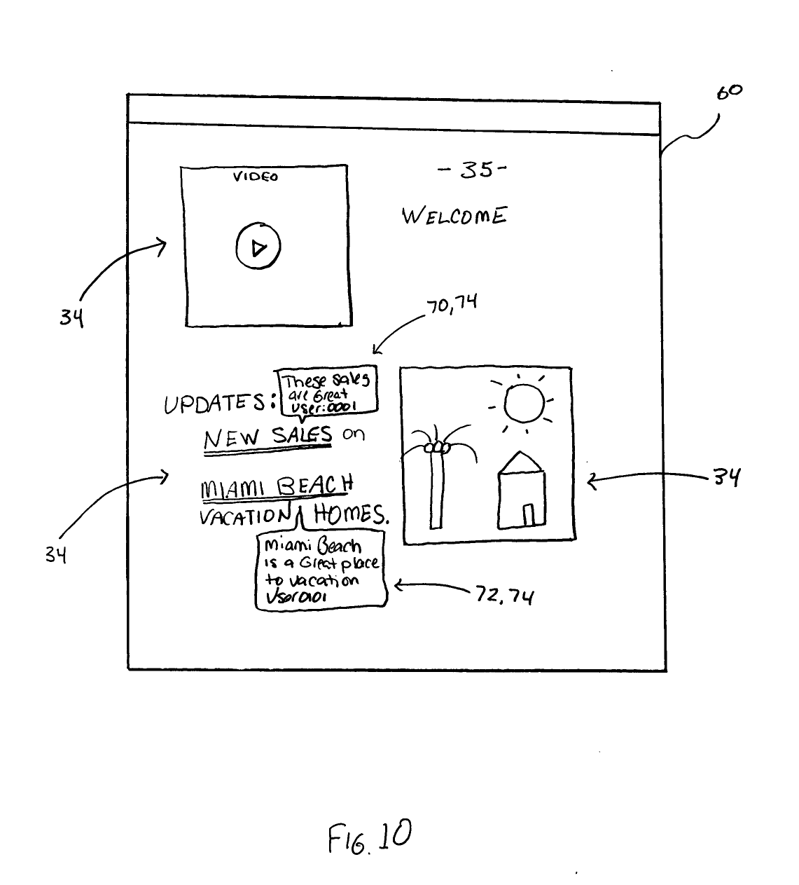

Like reference numerals refer to like parts throughout the several views of the drawings.

### DETAILED DESCRIPTION OF THE PREFERRED EMBODIMENT

The present specification includes at least one method for dynamically providing, in real-time, credible, relevant, and accurate guidance to a user via an interactive computer network, generally indicated as 100. In particular, as will be explained below, at least one embodiment of the present specification includes an interactive social network 10 and/or community which is cooperatively structured and disposed to unite, link, and/or otherwise interconnect a plurality of members 20, users, and/or residents with one another in any one or more manners, including, such as, for example, via direct invite and/or by virtue of two or more members 20 having one or more similar affinities. Moreover, the interactive social network 10 of at least one embodiment of the present specification is further structured and configured to enable, allow, or facilitate one or more members 20 or residents thereof to view, read, and/or evaluate various comments, reviews, opinions, videos, photographs, annotations, and/or other affiliated objects 30 which are directed to or otherwise correspond to virtually any product, service, web page, company, entity, association, and/or other web content 35 that the member 20 or user 21 is simultaneously viewing or accessing via the interactive computer network 40, such as the World Wide Web, and/or is otherwise associated with the interactive social network 10. In addition, the interactive social network 10 of at least one embodiment disclosed in the present specification includes an online marketplace where members 20 may browse, review, search, bid on, and purchase various items, product, or services. As such, a business, company, partnership, individual, or other entity selling a product or service may be a member 20 of the interactive social network 10 or otherwise associated therewith.

Accordingly, as will become apparent from the following discussion, the interactive social network 10 and/or community of at least one embodiment of the present specification includes a collection of social relationships or interconnections between a plurality of members 20 or residents. For example, each of the plurality of members 20 of the interactive social network 10 are interconnected or otherwise related to one or more other residents in any one or more of a plurality of manners, such as via private and/or personal network(s), common networks, and/or customized networks or networks within networks.

Furthermore, the interactive social network 10 of at least one embodiment of the present specification may be accessed by the user(s) 21 and/or member(s) 20 via an interactive computer network 40, which, as used herein, may generally refer to a collection of computer networks commonly known as the World Wide Web. Specifically, the World Wide Web represents a collection of computer networks cooperatively connected to each other and accessed by virtue of the Internet Protocol or other like protocols. It is contemplated, however, that the interactive social network 10 of the present specification may be accessed by virtually any interactive computer network 40, such as, for example, a Wide Area Network (“WAN”), Local Area Network (“LAN”), Intranet, peer-to-peer network, Blue Tooth network, mobile network, etc.

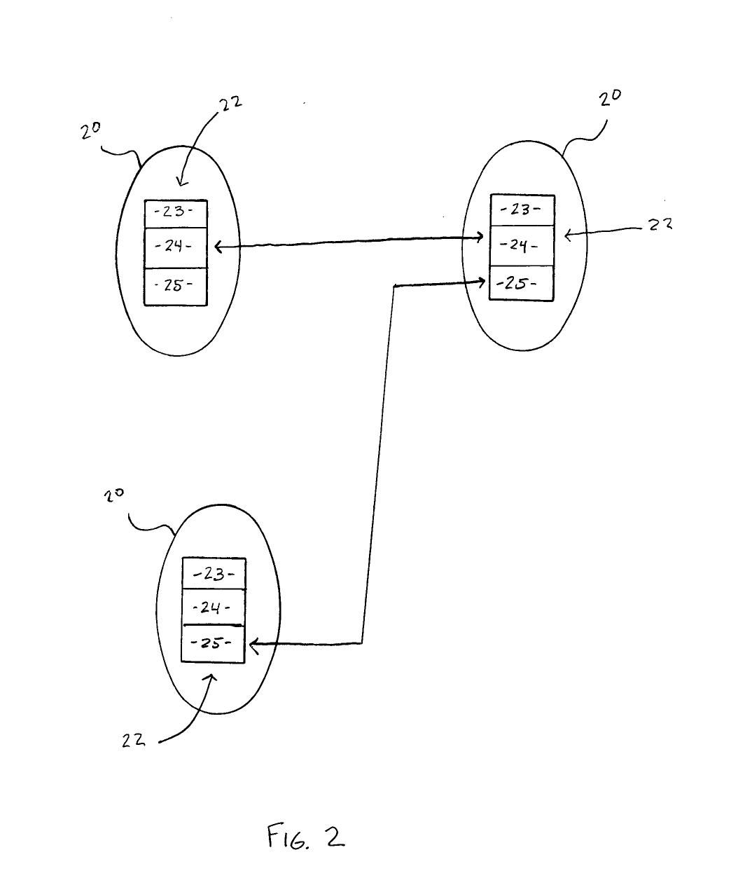

Moreover, as identified above, a member 20 or resident of the computer-related interactive social network 10 or community of at least one embodiment of the present specification may include, for example, any one or more individuals, partnerships, businesses, corporations, etc. Additionally, each member 20 of the interactive social network 10 of at least one embodiment of the present specification manages, controls, or is otherwise associated with a multi-tiered network system 22 or home. As best illustrated in FIG. 2, the multi-tiered network system 22 of at least one embodiment may include a plurality of network tiers or rooms, each of which may include one or more unique relationship classification schemes. In particular, each of the network tiers of at least one embodiment includes a unique level of privacy for the corresponding member 20 associated therewith, the significance of which will become apparent from the following discussion. Moreover, in at least one embodiment of the present specification, the member(s) 20 may control, edit, or otherwise configure various preferences, options, or other features or elements of the interactive social network 10 by virtue of a Graphical User Interface (“GUI”) accessed via the interactive computer network 40. As such, the present specification includes a filtering system which is at least partially based upon thresholds and/or attributes established, controlled, or configured by the user 21.

Still referring to FIG. 2, in at least one embodiment of the present specification, the multi-tiered network system 22 or home includes at least three (3) network tiers or rooms, including but not limited to a private tier 23, a semi-private tier 24, and/or a public tier 25. Of course, the present specification is not in any way limited to three (3) network tiers, and as such, any number of tiers may be contemplated. For instance, the present specification may include one (1), two (2), or more tiers. Further, the various members 20 of the interactive social network 10 of at least one embodiment of the present specification may be related to or otherwise interconnected with one or more other members 20 via any one or more of the various tiers, levels, or components of the multi-tiered network system 22. In particular, in at least one embodiment of the present specification, depending upon the level of trust and/or confidence one member 20 or resident has in one or more of the other members 20 or residents or groups of residents, as explained below, social network relationships or interconnections may be created, initialized, or set up by virtue of the various network tiers of the multi-tiered system 22. It should be apparent, however, that in at least one embodiment, the various interconnections and/or social relationships developed between two or more members 20 of the interactive social network 10 may be created independent of the network tiers and/or the multi-tiered network system identified herein.

In at least one embodiment of the interactive social network 10 of the present specification, the public tier 25 includes or is otherwise represented by a digital, electronic, or virtual area, zone, or feature of the interactive social network 10 wherein a member 20 may interact or associate with other members 20 or residents based upon one or more common affinities and/or interests. For example, a member 20 or resident of the interactive social network 10 of the present specification may be associated with one or more interests, hobbies, or other affinity groups. For example, in at least one embodiment of the present specification, via a GUI or other interface, the member(s) 20 are able to associate themselves with one or more hobbies, groups, or other affinities or common interests by adding, deleting, or modifying a profile or social network account associated with the particular member(s) 20 at any time. As used herein, the term affinities and/or common interests include, for example, interests, hobbies, membership groups, geographical locations, etc.

As such, and for exemplary purposes only, a member 20 of the interactive social network 10 of at least one embodiment of the present specification may belong to or otherwise be associated with a cooking group, a race car group, and/or a South Florida membership group, all of which may be considered hobbies, groups, common affinities and/or interests. For instance, a member 20 of the interactive social network 10 may associate themselves with various affinities, hobbies, products, services, etc. in order to be interconnected or related with other members 20′ whom the member 20 may trust or deem credible, the significance of which will become apparent from the following discussion. In addition, in at least one embodiment of the present specification, two or more members 20 having the same, related, similar, or matching interests or affinities are considered to be related to or interconnected with each other within the interactive social network 10 of the present specification by virtue of the public tier 25, the significance of which will become apparent from the following discussion. Furthermore, as will be discussed in more detail below, a member 20 who is related to or otherwise interconnected with another member 20′ within the interactive social network 10 by virtue of the public tier 25 may post comments, reviews, photographs, videos, or other annotations or objects within the other member's 20′ public tier 25. Accordingly, those individuals who have access to the other member's 20′ public tier 25 may view, read, or comment on the posted comment(s), review(s), photograph(s), video(s), annotation(s), or other object(s).

Furthermore, the member 20 may aggregate a plurality of affinities together and/or categorize or label one or more particular member(s) 20′ who belong to or associate themselves with the same or similar affinities so as to create one or more networks within networks. For example, a member 20 of the interactive social network 10 may be interconnected to fifty (50) other members 20′ by virtue of belonging to a similar group, such as a New England Patriots Fan Club. The member 20 may aggregate a South Florida Group with the New England Patriots Fan Club, which may then yield ten (10) members, for example. In addition, the member 20 may specifically categorize, choose, or label the one or more other members 20′ within any one or more networks or aggregated networks, based upon, for example, a particular trust level the member has with each particular other member 20′. Accordingly, the member 20 may choose three (3) of the ten (10) members who belong to the aggregated network of New England Patriots Fan Club and the South Florida Group to create yet another level of aggregated networks within networks.

In addition, two or more members 20 of the interactive social network 10 of at least one embodiment of the present specification may be related to one another by virtue of the semi-private tier 24, as identified above. In particular, a member 20 may specifically invite or associate with one or more friends, family, colleagues, classmates, or other acquaintances via any one or more of the various tiers, such as, for example, the semi-private tier 24, so as to initiate, set up, or otherwise create a social network relationship therewith. As such, in at least one embodiment, a member 20 who is related to or otherwise interconnected with another member 20′ by virtue of the semi-private tier 24 may post one or more comments, reviews, videos, photographs, annotations, or other objects within the other member's 20′ semi-private tier 24. In addition, within the semi-private tier 24, members 20 of at least one embodiment of the present specification may communicate with one another, watch shared videos, view shared photographs, etc.

Furthermore, the private tier 23 of at least one embodiment of the present specification includes a digital, electronic, or virtual area, zone, or feature within the interactive social network 10 or multi-tiered network system 22 which is only accessible, controlled, or managed by the corresponding member 20 associated therewith, or other specifically authorized individuals or entities. Accordingly, the private tier 23 of at least one embodiment is not an area or feature in which the members 20, 20′ can initiate, develop, or set up social network relationships with one another, but rather the private tier 23 is a feature or zone in which the corresponding member 20 associated therewith may store private information, photographs, videos, etc., sort through the member's 20 posted or developed network objects, including but not limited to comments, notes, videos, animations, sales, annotations, etc. In addition, the member 20 may draft reviews of products or services or other items, articles, web pages or web content 35. It should also be noted that, while logged in to the interactive social network 10 via the member's social network account, as disclosed in the present specification, the member 20 may browse the World Wide Web or other interactive computer network 40 by virtue of utilizing one or more features, search engines, web browsers, etc. incorporated or developed within the interactive social network 10.

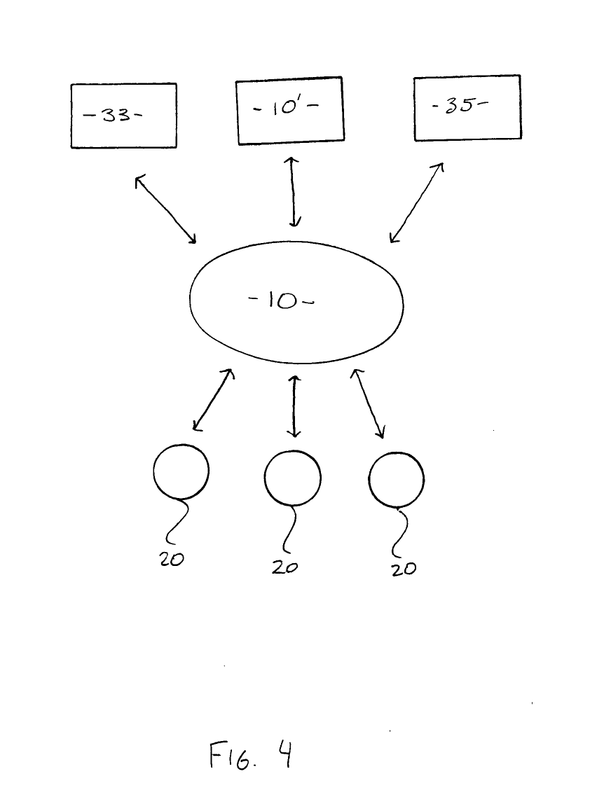

As will become apparent from the following discussion, and as generally and schematically illustrated in FIG. 4, the interactive social network 10 of at least one embodiment of the present specification may be developed, configured, and/or utilized as an e-commerce portal and/or information-gathering/developing tool. For instance, the present specification may be utilized to facilitate social commerce (“s-commerce”), wherein users or members are able to communicate with and/or assist each other while purchasing, reviewing, or researching products, services, companies, entities, etc. via the interactive computer network 40, such as the World Wide Web and/or the interactive social network 10. In particular, as will be discussed below, the interactive social network 10 of the various embodiments of the present specification may be developed or configured in which the various members 20 thereof are able to access, review, or analyze one or more affiliated objects, reviews, annotations, or network sales pertaining to requested web content 35 and/or web page(s) 33, in real-time, for example, as the member 20 navigates the World Wide Web, or other interactive computer network 40. Specifically, as discussed below, the affiliated object(s), review(s), annotation(s), and/or network sale(s) may include comments, photographs, videos, etc. posted within the interactive social network 10 or any Internet site 10′ by any member 20, 20′ or non-member of the interactive social network 10. A non-member of the interactive social network 10, as used herein, includes an individual or other entity who does not belong to the interactive social network 10, or has otherwise not created a social network account or profile with the interactive social network 10. Further, in at least one embodiment, the affiliated object(s) include those comments, reviews, annotations, sales, etc. posted or developed by another member 20′ of the interactive social network 10 interconnected to or otherwise related to the member 20 or user 21, for example, by virtue of belonging to one of the member's 20 tiers 23, 24, 25. The at least one other Internet site 10′ may include an online social network, such as, for example MYSPACE®, FACEBOOK®, and/or LINKEDIN®. In addition, the other Internet site 10′ of the present specification may include an online marketplace, such as eBAY® and/or AMAZON.COM® wherein users or members thereof may view, purchase, or sell products and/or services. In at least one embodiment, the present specification is structured to aggregate information and/or data which a member 20 has posted, written, associated with, or otherwise developed in one or more other various Internet site(s), including but not limited to social networking sites and online marketplace sites, in which a member is affiliated, into a central source, bringing together credible sources from the various Internet site(s) and displaying information, such as comments, reviews, etc., relevant to the content simultaneously being viewed by the user 21, in real-time. As such, a user 21 may view, access, or identify with various comments, reviews, sales, etc. posted by a member 20 interconnected with or related to the user 21 within the interactive social network 10, regardless if the comment, review, sale etc. is posted on or within the interactive social network 10, one or more other Internet site(s) 10′, or under a different name, identification, or association.

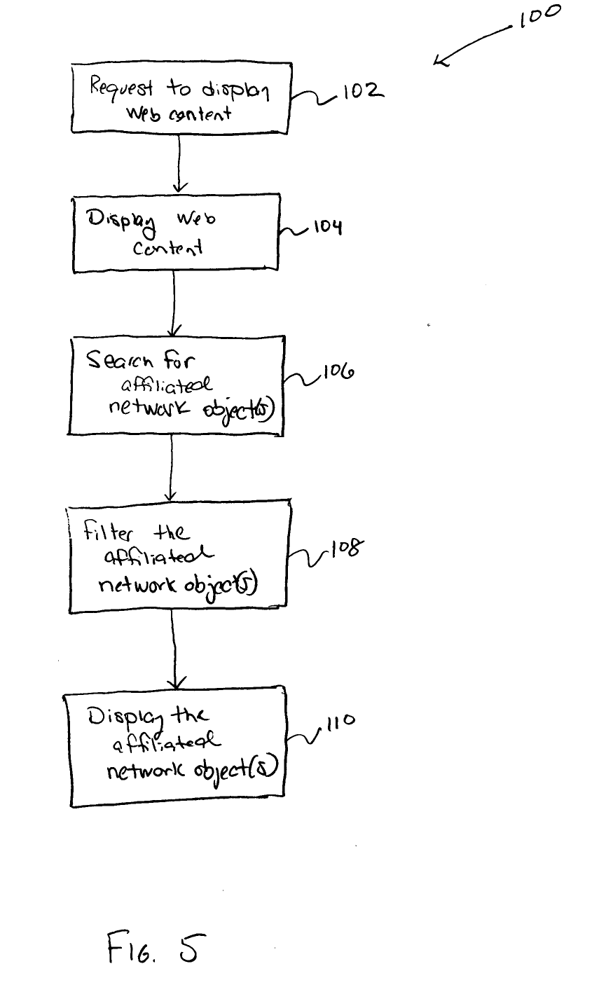

Referring now to FIG. 5, the method 100 of at least one embodiment of the present specification includes requesting, by a user via a client interface disposed in communicative relation with the interactive computer network, to display web content, as represented at 102. Moreover, the user 21, who in at least one embodiment belongs to the interactive social network 10, and is thus a member 20 thereof, may communicate a request 27 from a client interface 28 to a web server 30 and/or network/annotation server 50 disposed in a communicative relation with the interactive computer network 40. Moreover, the client interface 28 of at least one embodiment of the present specification includes virtually any computer or other like device such as, for example, a desktop computer, laptop computer, personal digital assistant (“PDA”), handheld computer, cellular telephone, video game console, or any other device structured to facilitate the practice of the present specification in the intended manner.

Furthermore, the user 21 of at least one embodiment communicates a request 27, such as, for example, a Hypertext Transfer Protocol (“HTTP”) request to a web server 30 and/or network/annotations server 50 via the interactive computer network 40. The web server 30 or network server 50 of at least one embodiment of the present specification includes virtually any computer or other like device structured to receive requests 27, such as HTTP requests, and serve responses, such as HTTP responses, via the interactive computer network 40. Accordingly, the web server 30 and/or network server 50 of at least one embodiment of the present specification includes, but is certainly not limited to, a server computer, desktop computer, laptop computer, PDA, handheld computer, cellular telephone, video game console, etc. In particular, the one or more web server(s) 30 generally include an electronic storage medium 32 having various web content 35, such as one or more web sites or web pages 33 stored thereon.

In at least one embodiment, the network/annotation server(s) 50 as used herein is generally affiliated with the interactive social network 10 by virtue of storing various data associated therewith, such as, for example, account information or data pertaining to members 20, 20′ of the interactive social network 10. In addition, as will become apparent from the following discussion, the network/annotation server(s) 50 of the present specification may also include an electronic storage medium which is structured to store various web content 35, network comments, reviews, annotations, and/or other network objects.

Moreover, the web content 35 of at least one embodiment of the present method 100 may include virtually any textual, visual, and/or aural content, such as, text, images, sounds, video, animation, etc., which may be included within one or more web sites, web pages 33, or other data or information accessible via the interactive computer network 40 and/or the interactive social network 10. In particular, the web content 35 of at least one embodiment may, but need not be at least partially related to commerce, such as, for example, electronic commerce (“e-commerce”) and/or other transactions which may occur via the interactive computer network 40 and/or independent of the interactive computer network 40. For example, the web content 35 may include one or more web sites and/or web pages 33 which facilitate a user 21 to purchase a product and/or service directly thereon. The web content 35 may describe, illustrate, provide specifications for, or otherwise inform a user 21 about various aspects of a product and/or service which may or may not be purchased via the web site and/or web page(s) 33. In addition, however, the web content 35 of at least one embodiment of the present specification may illustrate, describe, provide specifications for, or inform a user 21 about a location, an object, a product or service, an individual, partnership, company, association, or other entity. Either way, the web content 35 of at least one embodiment of the method 100 of the present specification may be at least partially related to commerce by virtue of informing a user 21 viewing the web content 35 of details, specifications, illustrations, descriptions, etc. of one or more products, services, individuals, partnerships, companies, or other entities, etc. Of course the web content 35 of the present specification need not be related to commerce at all, and for illustrative purposes only, may include information or data relating to travel, vacation spots, geographical locations, areas, or structures, restaurants, shows, movies, etc.

Further, in at least one embodiment of the method 100, the user 21 may utilize a web browser 60 disposed on or in a communicative relation with the client interface 28. For instance, the user 21 may request the web content 35 by virtue of entering any valid or active web address into the web browser 60, and/or by entering or communicating one or more search queries into a search engine via the web browser 60 or other like structure or device. The web browser 60 may be associated with, specifically configured with, or independent from the interactive social network 10 disclosed in the present specification. Accordingly, the requested web content 35 may include contents of one or more web page(s) 33, and/or other information, data, or content received in response to the search query, or other such request(s).

Additionally, as illustrated in FIG. 5, the method 100 of the present specification further includes displaying to the user via the interactive computer network, the web content, as shown at 104. As such, the web content 35, which, as identified above, may include virtually any web page 33, results from a search query, and/or information or data obtained from or contained within the interactive social network 10, etc., may be displayed to the user 21 via the web browser 60 and/or any other manner which facilitates the practice of the present specification in the intended manner.

Furthermore, at least one embodiment of the method 100 of the present specification includes searching for at least one affiliated network object and/or at least one affiliated network sale, wherein the affiliated network object(s) and/or network sale(s) is at least partially related to the web content, as illustrated at 106. In particular, any one or more members 20, 20′ of the present specification is capable of posting or otherwise developing one or more reviews, opinions, comments, annotations, or other objects and/or media objects, which may be in the form of text, video, images, and/or audio. Furthermore, as will be explained in more detail below, the network object(s) of the present specification may include a network sale such as an offer for sale or auction of a product or service.

Moreover, in at least one embodiment of the present specification, the various objects(s), which, as above, may include comment(s), suggestion(s), opinion(s), video(s), animation(s), photograph(s), sale(s), etc., may be developed or otherwise posted in any one or more of the network tiers of the multi-tiered system 22 associated with any one or more members 20, 20′. For example, a member 20 who is related to or otherwise interconnected with another member 20′ of the interactive social network 10 may post one or more objects on or within the other member's 20′ network tier(s) to which he/she belongs. Specifically, as identified above, a member 20 may be related to another member 20′ by virtue of having one or more of the same or similar affinities. In such an instance, the member 20 may post a comment in the other member's 20′ public tier 25, as identified above. If, however, the member 20 has been specifically invited to belong to the other member's 20′ semi-private tier 24, the various comment(s), annotation(s), video(s), photograph(s), or other object(s) may be posted or otherwise developed in the other member's 20′ semi-private tier 24. Accordingly, and as identified above, at least one embodiment of the present specification includes a filtering system at least partially based upon one or more thresholds and/or attributes established, controlled, or configured by a user 21 and/or other member 20 of the interactive social network 10.

In yet another embodiment, the member 20 of the interactive social network 10 of the present specification may also belong to one or more other social networks, e-commerce networks, online marketplaces, and/or other Internet site(s) 10′, which may include, but are not limited to, for example, MYSPACE®, LINKEDIN®, FACEBOOK®, eBAY®, AMAZON.COM®, YELP®, TRIPADVISOR®, etc. As such, by virtue of the structure, feature(s), or interaction of the other Internet site(s) 10′, the member 20 may typically post or otherwise develop one or more comments, videos, pictures, etc. within the other Internet site(s) 10′, for example, on a profile or bulletin associated therewith. In addition, the member 20 may offer a product or service for sale or auction at an online marketplace or other Internet site(s) 10′, such as eBAY® or AMAZON.COM®. Accordingly, a network object, as used herein, includes virtually any comment, opinion, video, photograph, sale etc. posted or developed by a member 20, 20′ or non-member of the interactive social network 10, whether the object is developed or posted within the interactive social network 10, the interactive computer network 40, and/or any other Internet site(s) 10′.

As such, at least one embodiment of the method 100 of the present specification may search, for example within the interactive social network 10 and/or other Internet site(s) 10′, such as MYSPACE®, FACEBOOK®, LINKEDIN®, eBAY®, AMAZON.COM® etc. for an affiliated network object 52. In at least one embodiment, an affiliated network object 52 includes any comment(s), review(s), opinion(s), video(s), photograph(s), picture(s), animation(s), or other network object(s), etc. which is at least partially related to the requested web content 35. For example, the method 100 of at least one embodiment may include evaluating the web content 35 and/or identifying a general topic, subject matter, genre, company, web site, product, service, entity, etc. associated with the web content 35. Accordingly, the method 100 may analyze the web address, the search query, the web page 33 itself, or any other data or information to obtain a topic, subject matter, genre, etc. associated therewith. In at least one embodiment, an affiliated network object 52 is thus any network object, such as a comment, review, opinion, suggestion, note, video, animation, etc. posted or developed by a member 20, 20′ or non-member of the interactive social network 10 which is at least partially related to the requested web content 35, for example by virtue of having a similar topic, genre, subject matter, etc.

For exemplary purposes only, a member 20 of the interactive social network 10 may post or develop a network object, such as in the form of a comment or suggestion, directed to a movie, within one or more of the network tiers associated with another member 20′. As such, the network object may, for example, include a comment having the following text: “I went to see a new movie called AMERICAN PIE®. I enjoyed it, and I think you should go see it.” Accordingly, this illustrative example of one network object in the form of a comment or review may be at least partially related to a web page associated with movies in general, a movie theater web page, a web page specifically associated with the movie AMERICAN PIE®, a web page associated with the cast of AMERICAN PIE′, etc. It should be apparent, however, that a network object need not be posted within the user's network tier(s). For instance, in at least one embodiment, as long as the member 20 who posted the network object and/or affiliated network object 52 is related to or otherwise interconnected with the user, when the user enters a web address, search query, etc. the affiliated network object 52 will appear as being at least partially related to the web content.

In at least one embodiment wherein the method of the present specification searches other Internet site(s) 10′ for an affiliated network object 52, the present specification may first include authorizing whether the method searches other Internet site(s) 10′. For example, the user 21 or member 20 who developed or posted the comments, review, sale, etc. may not want the other Internet site(s) 10′ to be searched for their comments, reviews, sales, etc.

In addition, the affiliated network object(s) 52 of at least one embodiment of the present specification may be directly related to the requested web content 35 by virtue of being developed on the web page 33 itself, or otherwise specifically directed toward the content thereon. For instance, rather than being posted on or within another member's 20′ network tier, such as the public and/or semi-private tiers 25, 24, respectively, the illustrative example of an affiliated network object 52 in the form of a comment/review identified above may be posted directly on a movie theater's web page, or directly on a web page associated with the movie AMERICAN PIE®. Either way, a network object that is at least partially related to the requested web content 35, whether it be directly or indirectly related thereto, is an affiliated network object 52, as such term is used herein.

Furthermore, as identified above, the various network objects(s) in at least one embodiment of the present specification are stored or otherwise disposed on or in a communicative relation with an electronic storage medium or one or more network/annotation server(s) 50. The network/annotation server(s) 50 is disposed in a communicative relation with the interactive computer network 40, and as such, in response to the request 27 from the user 21, the method 100 of at least one embodiment of the present specification includes dynamically searching, in real time, for any one or more affiliated network objects 52. Accordingly, as the user 21 navigates the Internet, for example, by searching for various products, services, hotels, motels, travel agencies, vacation spots, movies, shows, or other information, the method 100 of the present specification continuously, automatically, and dynamically updates the affiliated network object(s) 52 associated with or related to the web content 35.

Additionally, in at least one embodiment, the affiliated network object(s) 52 is associated with a member 20, 20′ of the interactive social network 10 who created, developed, or otherwise posted the affiliated network object(s) 52. Accordingly, the affiliated network object(s) 52 of the present specification may or may not be associated with a reliable or credible source. Thus, at least embodiment of the method 100 of the present specification further includes filtering the at least one affiliated network object in accordance with a network relationship criteria, represented as 108. For example, the present method 100 may include determining a network relationship status corresponding between the user 21 and the author, creator, or member 20, 20′ of the interactive social network 10 associated with the at least one affiliated media object 52. In particular, based upon the relationships and/or interconnections between the various members 20, 20′ of the interactive social network 10, the network relationship status corresponding between the user 21 and the author(s), creator(s), and/or member(s) 20, 20′ associated with the affiliated network object 52 may be determined or calculated. For example, as identified above, the user 21 has control of and may create, modify, or manage which members 20, 20′ if the interactive social network 10 to be related or interconnected to. For example, as explained above, the user 21 or other member 20, 20′ of the interactive social network 10 may manage networks or tiers by selecting affinities and/or specific members to relate with. Similarly, the user 21 and/or other members 20, 20′ may create or manage networks within networks, and thereby create various levels of trust, credibility, and confidence with other members of the interactive social network 10.

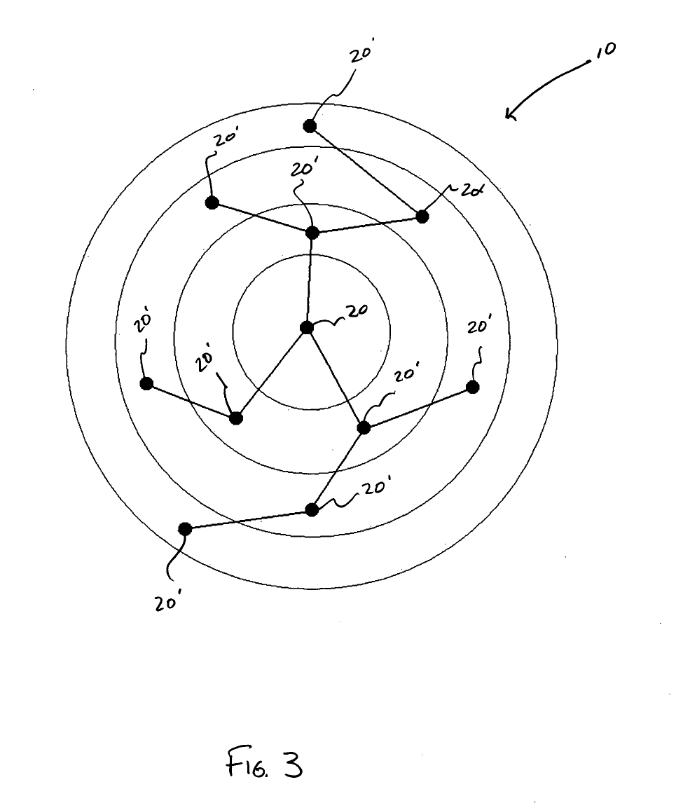

Moreover, as best illustrated in FIG. 3, the network relationship status corresponding between various members 20, 20′ of the interactive social network 10 may be determined or calculated based upon a degree of separation value or element. For example, each ring 12, 14, 16 illustrated in FIG. 3 represent a particular degree of separation corresponding between members 20 and 20′. In particular, members 20′ disposed in ring 12 of FIG. 3 are directly related to or otherwise interconnected with member 20 by virtue of one or more affinities or by being specifically invited to the semi-private tier 24, and include a network relationship status of one (1) degree of separation. Similarly, the members 20′ disposed in ring 14 illustrated in FIG. 3 include a network relationship status of two (2) degrees of separation from member 20. Finally, those members 20′ of the interactive social network 10 disposed in ring 16 include a network relationship status of three (3) degrees of separation from member 20. Of course, the degrees of separation of the present invention are not limited to the three (3) degrees of separation illustrated in the example shown in FIG. 3.

Additionally, at least one embodiment of the method 100 of the present specification includes, if the network relationship status satisfies a network relationship criteria, displaying to the user via the interactive computer network, the at least one affiliated network object, illustrated at 110. Moreover, in at least one embodiment, the network relationship criteria includes a formula, number, or rule pertaining to or including, for example, a degree of separation and/or one or more affinities, which are then compared to the network relationship status. For exemplary purposes only, the network relationship criteria in at least one embodiment of the present specification may include two (2) degrees of separation. As such, if the member 20, 20′ associated with the affiliated network object 52 is related to or interconnected with the user 21 by two (2) degrees of separation or less (i.e., the media object entity falls within ring 12 or 14 as illustrated in FIG. 3 relative to member 20), then the affiliated network object 52 is displayed to the user 21 for example, via a web browser 60.

Additionally, the network relationship criteria of the present specification may include multiple criteria or a network within a network, for example, a degree of separation and/or one or more affinities or a selected set of at least one or more affinities. Accordingly, and for illustrative purposes only, the network relationship criteria may include two (2) degrees of separation, a South Florida Group, and/or a National Football League Fan Group. As such, if the member 20, 20′ of the interactive social network 10 or other entity associated with the affiliated network object 52 is within two (2) degrees of separation and belongs to both the South Florida Group and/or the National Football League Fan Group, then the affiliated network object 52 is displayed to the user 21.

It should be apparent that the user 21 may, in at least one embodiment of the present specification, choose, adjust, manage, or modify the network relationship criteria as he/she chooses or desires. As such, the user 21 may, in essence, control or manage which affiliated network objects 52 are displayed based upon, for example, the user's 21 trust or confidence in the various members 20, 20′ of the interactive social network 10. Furthermore, as the user 21 navigates from one web page 33 to another, or as the user 21 enters different search queries, etc., the method 100 of the present specification dynamically filters the affiliated network object(s) 52, in real time, depending on the requested web content 35. Accordingly, the method 100 of the present specification filters the affiliated network object(s) 52, and displays those affiliated network objects 52 that satisfy a network relationship criteria, which may be set or controlled by the user 21. This allows the user 21 to review, analyze, and/or otherwise consider the comments, reviews, opinions, etc. of those members 20, 20′ which are within his/her network by virtue of being related to or interconnected with the user 21 via the interactive social network 10.

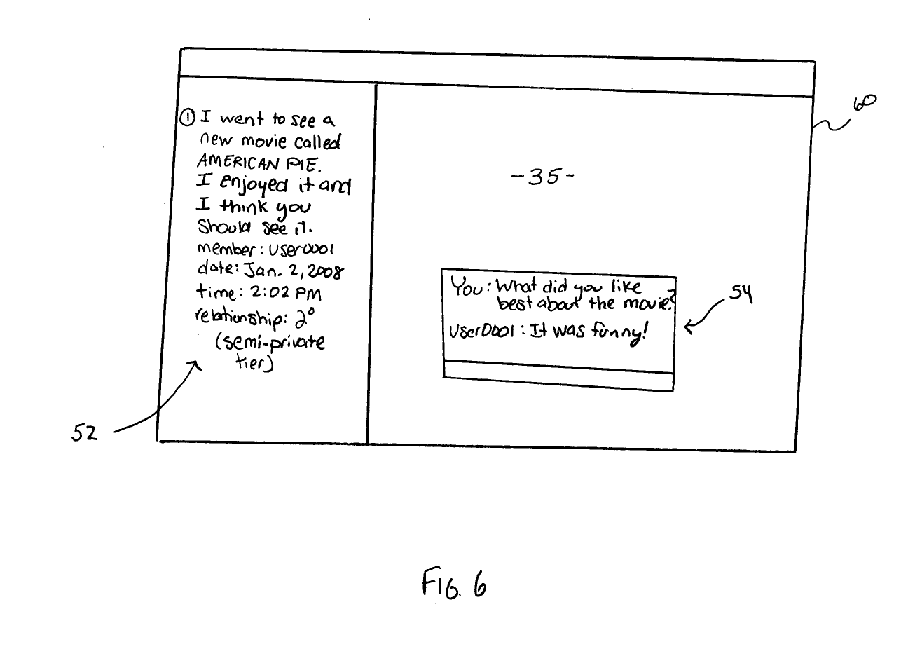

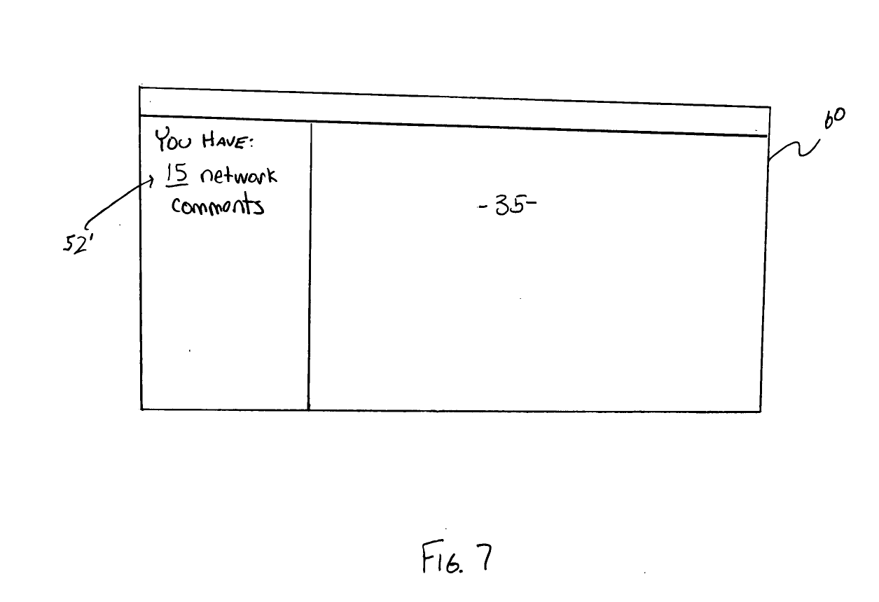

Furthermore, as illustrated in FIG. 6, the web browser 60, in at least one embodiment, may display the affiliated network object(s) 52 contemporaneously with the requested web content 35, such as, for example a web page 33. Of course, the affiliated network object(s) 52 and the requested web content 35 may be disposed in or otherwise separated into different panels or frames within the web browser 60. Additionally, however, as illustrated in FIG. 7, in yet another embodiment, the web browser 60 or other application or structure may display one or more network object indicators 52′, which indicate to the user 21, for example, the total number of affiliated network objects 52 that are at least partially related to the requested web content 35. Accordingly, in response to one or more predetermined events, such as, for example, a user 21 clicking on or hovering a mouse or other pointing device over the network object indicator 52′, the affiliated network object 52 is displayed to the user 21.

In addition, at least one embodiment of the method 100 of the present specification includes displaying to the user 21 via the interactive computer network 40, the network relationship status. Accordingly, in addition to viewing the various affiliated network objects 52, the user 21 may also view the network relationship status associated between the user 21 and the author, creator, or other member 20, 20′ associated with each affiliated network object 52, such as, for example, the degrees of separation between the user 21 and the author, how the user 21 and the author, creator, or other member 20, 20′ are interconnected or related, and/or any one or more shared affinities. This, in essence, allows the user 21 to evaluate the credibility and/or trust of the affiliated network object(s) 52 by virtue of its source and the network relationship status associated therewith. In such an instance, the method 100 may or may not filter the affiliated network object(s) 52 in accordance with a network relationship criteria, as identified above.

Furthermore, in at least one embodiment of the present specification, the method 100 includes providing an interactive communication module 54 for communication between the user 21 and the member 20, 20′ of the interactive social network 10 associated with the affiliated network object 52. For example, the interactive communication module 53 of at least one embodiment of the present specification may include a chat box or other like module which facilitates live communication between the user 21 and the member 20, 20′ associated with the affiliated network object 52. In such an instance, the user 21 may ask questions or open dialogue with the member 20, 20′ for example about the web content 35 and/or the affiliated network object(s) 52. Allowing the user 21 to communicate with the member 20, 20′ may assist the user 21 with the development of information or data regarding the requested web content 35, which as above, may include, for example, products or services the user 21 is interested in purchasing or information about a service, product, company, entity, hotel, motel, travel agency, movie, show, restaurant, vacation spot, etc. In at least one embodiment, the user 21 may choose an option, link, or other structure which opens or activates the interactive communication module 54. In addition, the interactive communication module 54 of the present specification may include an e-mail program, message module, or other like device structured to allow the user to send the member 20, 20′ associated with the affiliated network object(s) 52 an e-mail or message which may be read or viewed instantly and/or at a later time.

In at least the embodiment of the present specification, the method 100 includes converting the network object(s) into an audible format. In particular, as described above, a member 20 of the interactive social network 10 may post comments, reviews, opinions, etc. within the interactive social network 10, for example, on or within another member's 20′ multi-tiered network system 22. At least one embodiment may convert those comments, reviews, opinions, etc. into an audible format, either automatically or upon a member's 20, 20′ request. As such, in at least one embodiment, the present invention includes a text-to-speech system (“TTS”) and/or speech synthesizer so as to convert the textual content into speech.

The converted comments, opinions, reviews, etc. may then be accessed or heard by the authorized member(s) 20, 20′ of the interactive social network 10 via telephone, computer, or other communication device or structure.

As briefly mentioned above, in yet another embodiment of the present specification, the method 100 includes searching the interactive social network 10 for at least one affiliated network sale, wherein the at least one affiliated network sale is at least partially related to the requested web content 35. In particular, an affiliated network sale, as used herein, includes any one or more products and/or services being sold and/or offered for sale by any one or more members 20, 20′ of the interactive social network 10, wherein the products and/or services are at least partially related to the web content 35 requested by the user 21 or displayed to the user 21. The method 100 of at least one embodiment of the present specification further includes filtering the affiliated network sale(s) in accordance with at least one network relationship criteria. As such, while a user 21 simultaneously navigates the World Wide Web or other interactive computer network 40 in search for virtually any web content 35, the method 100 of the present specification is structured to dynamically search and/or filter, in real-time, one or more affiliated network sales at least partially related to the requested web content 35.

A network sale, as used herein may include any sale or auction of any product or service offered for sale by a member 20, 20′ of the interactive social network 10 of the present specification. In at least one embodiment, the network sale may be created, posted, or developed within the interactive social network 10, for example, via one or more stores or other features which facilitate members 20, 20′ to offer products or services for sale or auction. In addition, however, in at least one embodiment, a network sale may include a sale or auction offered by a member 20, 20′ of the interactive social network 10 or at least one other Internet site(s) 10′, such as, for example, eBAY® or AMAZON.COM®. Similar to the affiliated network object(s) 52 identified above, an affiliated network sale is at least partially related to the requested web content 35, for example, via a common or related genre, subject matter, theme, or topic.

An identification of the affiliated network sale(s) of at least one embodiment of the present specification may be displayed to the user 21, for example, as the user 21 navigates from one web page 33 to another. For illustrative purposes only, a user 21 may request web content 35 directed to one or more portable mp3 players, such as an APPLE iPOD®. Accordingly, while viewing a web page 33 which offers information about or sells portable mp3 players, at least one embodiment of the method 100 of the present specification will search for an affiliated network sale related to portable mp3 players and identify them to the user 21. For instance, the method 100 may indicate to the user 21 that a member 20, 20′ of the interactive social network 10 who is related to or otherwise interconnected to the user 21, such as via a certain degree of separation, is offering to sell a portable mp3 player, a carrying case for a portable mp3 player, a power cable for a portable mp3 player, or any other affiliated network sale(s) at least partially related to the requested web content 35. Similar to the affiliated network object(s) 52 described above, the affiliated network sale(s) may be filtered in accordance with a network relationship criteria. Accordingly, in at least one embodiment, the user 21 may be aware that the affiliated network sale is from a credible, relevant, and reliable source.

Again, for illustrative purposes only, a user 21 may request web content 35 directed to a hotel, for example by entering “www.holidayinn.com” into a web browser 60. The method 100 of the present specification will identify the genre or subject matter of the requested web content 35 and search for affiliated network object(s) 52 and/or affiliated network sales at least partially related to hotels, travel, car rentals, HOLIDAY INN®, etc. Once at the HOLIDAY INN® web page, the user 21 may narrow the web content 35, for example, by searching the HOLIDAY INN® web site for hotels in Miami, Fla. Accordingly, the method 100 of at least one embodiment of the present specification is structured to dynamically search for affiliated network object(s) 52 and/or affiliated network sale(s) at least partially related to the requested web content 35. As such, at least one embodiment may display affiliated network object(s) 52 and/or affiliated network sale(s) at least partially related to travel, hotels, HOLIDAY INN′, hotels located in or near Miami, Fla. and/or travel destinations and/or attractions located in or near Miami, Fla. The user 21 may request web content 35 on the same HOLIDAY INN® web page associated with hotels in Miami, Fla. during a particular time frame or range of dates. As such, at least one embodiment of the present method 100 will dynamically update the affiliated network object(s) and/or affiliated network sales according to the chosen range of dates.

The present specification further includes a business-type method structured to maximize commerce and/or revenue for a seller, wherein the seller may sell or offer to sell virtually any product and/or service across one or a plurality of distribution channels accessible, for example via an interactive computer network 40 such as the World Wide Web, and/or an online marketplace, such as the interactive social network 10 disclosed in accordance with the present specification. For example, the seller or other entity may provide a plurality of descriptions for any one particular product and/or service. In at least one embodiment, the plurality of descriptions for the particular product and/or service may vary, for example, in degrees of specificity, wherein the more general the description the lower the selling price of the product and/or service. Along the same lines, as the description of the product and/or service becomes more specific, for example, by providing more details, such as photographs, dimensions, weight, days of travel, etc., the more expensive the product and/or service becomes. In at least one embodiment, the seller may provide one or more descriptions of the product and/or service which is accessible by a purchaser, prospective purchaser, or other user via an interactive computer network 40 such as, for example, by virtue of being incorporated into a web page.

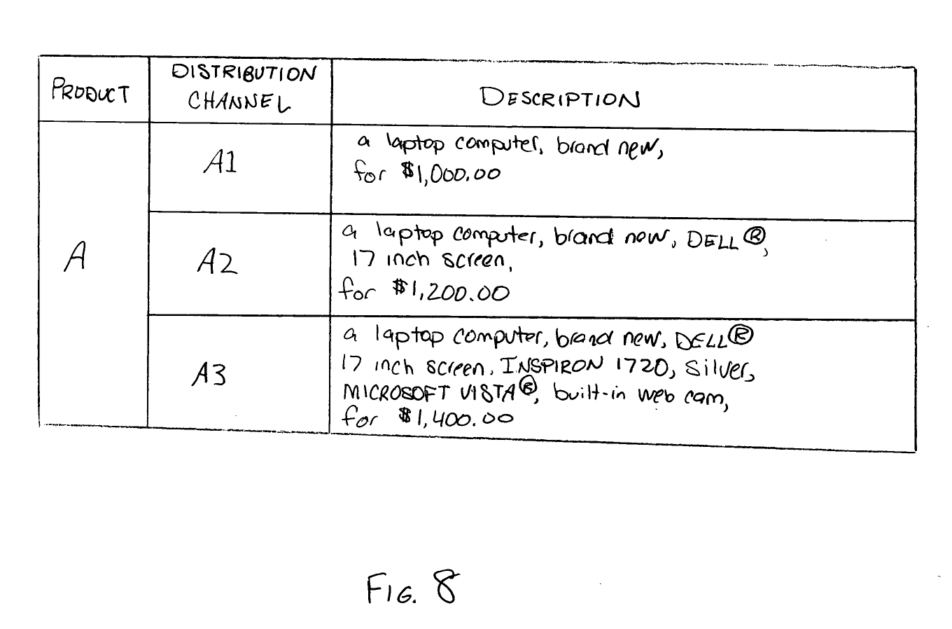

Furthermore, in at least one embodiment, the purchaser and/or prospective purchaser of the product and/or service will be unable to connect, link, or associate the products and/or services being offered on different distribution channels. For illustrative purposes, Product A may be sold on three (3) different and unique distribution channels (e.g., distribution channels A1, A2, and A3), wherein each distribution channel A1, A2, A3 includes a unique description of Product A. As such, each of the unique descriptions for Product A includes a unique degree of specificity. For example, and as illustrated in FIG. 8, distribution channel Al may include a rather vague and broad description of Product A, whereas distribution channel A3 may include a rather specific description of Product A. Moreover, in at least one embodiment of the present specification, the purchaser will not be able to identify that Product A in distribution channel A1 is the exact same product as Product A in distribution channel A2 or A3. Accordingly, each distribution channel A1, A2, A3 of at least one embodiment is completely independent and/or exclusive from any other distribution channel A1, A2, A3.

In particular, at least one embodiment of the present specification includes matching the seller and purchaser with the maximum price the purchaser is willing to pay for the particular product and/or service. In essence, the method of at least one embodiment funnels or filters the available products and/or services based upon what the purchaser determines to be the most important or essential features, functions, or elements of the particular product and/or service. Accordingly, in at least one embodiment, the purchaser is matched up with or otherwise receives information pertaining to at least one distribution channel A1, A2, A3 depending upon, for example, the purchaser's search query, answers to questions, etc. indicating which features, functions, or structures of the product or service are most important or essential.

For exemplary purposes only, as shown in FIG. 8, a seller may offer to sell a product A, such as a laptop computer in three (3) unique distribution channels A1, A2, A3 via an interactive computer network 40. One distribution channel A1 may include the following description of the laptop computer: “a laptop computer, brand new, for $1,000.” Another distribution channel A2, having a more detailed or specified description of the features, functions or elements of the same particular laptop may include the following: “a laptop computer, brand new, DELL®, 17 inch screen, for $1,200.” Yet another distribution channel A3 having an even more detailed description of the feature, functions, or elements for the same particular laptop may include the following: “a laptop computer, brand new, DELL®, 17 inch screen, INSPIRION® 1720, silver, MICROSOFT VISTA®, built-in web cam, for $1,400.” Accordingly, a purchaser or prospective purchaser searching for a laptop computer, for example, via a web browser 60, a search engine, and/or the interactive social network 40 of the present specification, may purchase the particular laptop in any one of the various distribution channels A1, A2, A3 described above depending upon the features, functions, or elements which the purchaser deems most important or essential.

Furthermore, at least one embodiment of the present specification includes an automatic product and/or service listing. In particular, once the purchaser purchases a product and/or service, for example, from at least one of the plurality of distribution channels A1, A2, A3 identified above, the particular product that was purchased is removed from each one of the plurality of distribution channels A1, A2, A3, and not merely the one distribution channel from which the product and/or service was purchased. In such an instance, if the seller has one or more similar products and/or services to sell or offer to sell, at least one embodiment of the present specification automatically replaces or re-lists the sold product(s) and/or service(s) with a new product and/or service being associated with the same plurality of distribution channels A1, A2, A3, and thus, having the same or similar plurality of descriptions varying in specificity, and the same or similar plurality of prices depending upon the various descriptions and distribution channels A1, A2, A3.

Further, in at least one embodiment of the present specification, the seller may create, add, set, modify, or otherwise configure one or more thresholds and/or variables which are evaluated prior to automatically re-listing or replacing the sold product and/or service with a new similar product and/or service. For instance, when a seller initially places a product or service for sale, for example, by utilizing the method of the present invention, and/or by posting the product and/or service for sale via the interactive social network 10, the seller may configure or control one or more thresholds directed to monthly revenue, income, units sold, occupancy rate of a hotel, motel, or inn, level of demand, etc. For example, when listing a product and/or service, the seller may specify periodic inventory goals, such as the number of units the seller has at the beginning of the month and the number or percentage of units in which the seller would like to have at the end of the month. In at least one embodiment, based upon the threshold(s) established by the seller, the listing price will automatically be adjusted in accordance with the threshold(s).

In addition, the seller may specify financial goals or thresholds which may differ for each of the plurality of distribution channels A1, A2, A3 described above. In any event, the method of at least one embodiment of the present invention automatically posts or lists the products and/or services for sale depending upon the various thresholds specified by the seller. Accordingly, the prices and/or description of the particular products and/or service of at least one embodiment periodically and automatically change depending upon the various thresholds, such as, for example, the inventory and/or financial goals, specified by or on behalf of the seller.

As yet another illustrative embodiment, a travel supplier may sell an identical product or service via a plurality of distribution channels. For example, in at least one distribution channel the seller or, in this instance the travel supplier, may provide negotiable rates which are to be sold through a packaged deal. In at least one embodiment, the packaged deals are only available for prospective purchasers who complete a request for quotation (“RFQ”) relating to at least one facet of travel. Further, in at least one embodiment, the purchaser is not advised of the specific cost structure for each of the two facets of travel, and as such, the price may be adjusted or reduced in light of the same.

An individual or computer receiving the RFQ, such as, for example, a certified travel agent, may respond to the prospective purchaser using, for example, information relating to negotiate inventory which the interactive social network 10 has established. The prospective purchaser may then interact with the individual or computer, such as the certified travel agent. In addition, it is contemplated that the prospective purchaser may limit or otherwise choose which type of individual or travel agent to interact with or receive quotes from. For example, if a prospective purchaser is traveling to Miami Beach, Fla. from. New York, N.Y. requesting air fare and hotel information, the prospective purchaser may specify that only travel agents or individuals located at or near Miami, who are more likely to be familiar with the area, can respond or interact with the prospective purchaser.

Furthermore, in one embodiment, at least one distribution channel includes an auction-based format to purchase the identical product(s) and/or service(s) offered in other distribution channels. Although, in at least one embodiment, the auction may include a single facet of travel, various details of the product(s) and/or service(s) may be withheld from the purchaser, such as the brand name, location, time of travel, etc. Under this embodiment, revenue for the seller is maximized in which the product(s) and/or service(s) is likely to be sold for its maximum purchase price via the auction based format.

Moreover, the purchaser may purchase the product(s) and/or service(s) having knowledge of various details concerning the product(s) and/or service(s), such as brand name, time and date of travel, locations, etc., and as such, little to no discount on the price or cost is offered.

In addition, the prospective purchaser and/or user may create a specific itinerary, for example, hour by hour, wherein members 20, 20′ within the user's social network via the interactive social network 10 of the present specification may assist in the development of such an itinerary. Specifically, as identified above, as the user 21 navigates the World Wide Web or otherwise requests web content 35, such as by identifying specific itinerary details, the user 21 is provided, in real time, affiliated network objects 52 such as comments, reviews, etc. as well as interactive communication modules, such as live chats, instant messages, e-mail, etc. for a complete open dialogue, information gathering experience.

In yet another embodiment of the present specification, in addition to posting network objects, a member 20, 20′ of the interactive social network 10 may provide a score or ranking for a particular product, company, travel location, hotel, airline, etc. For example, the interactive social network 10 or other system may provide the ability for members 20, 20′ to indicate a number, letter, or other scoring or ranking indicia related to virtually any product, company, web page, etc.

Accordingly, as a user 21 searches the World Wide Web or other interactive computer network 40, or otherwise requests web content 35, at least one embodiment of the present specification includes providing the user 21 with a network score at least partially related to the requested web content 35. In particular, the present method may indicate scores or rankings which members 20, 20′ of the interactive social network 10 have previously indicated for the web content 35 that the user 21 is currently viewing. The scores and/or rankings may be filtered in accordance with a network relationship criteria such that the user 21 is provided scores and rankings from members 20, 20′ within which the user 21 is related or interconnected to within the interactive social network 10. This assures the user 21 that the rankings are reliable and credible as coming from a known source.

In addition to dynamically providing the score(s) and/or ranking(s) to the user 21, the method of the present specification may also determine and provide a network relationship status the user 21 has with the creator of the score or ranking, which will allow the user 21 to determine which rankings or scores are credible and/or reliable. The method of the present invention may further dynamically average the rankings and/or scores, in real-time, as the user navigates the World Wide Web.

In yet another embodiment, the present specification includes providing, real-time, live virtual interaction between the seller and the user 21, such as a prospective purchaser(s). In particular a seller, which may include a member 20, 20′ of the interactive social network 10, a store and/or business associated with or belonging to the interactive social network 10, etc., may utilize a camera, such as a web cam to show themselves and/or their products, stores, advertisements, etc.

In addition, while the seller is displaying their product(s), store(s), services(s), etc. the users 21, for example, purchasers or prospective purchasers may communicate with each other and/or the seller by asking questions, producing comments, opinions, reviews, etc. in real-time. In at least one embodiment, the present specification includes identifying to the user 21 which members 20, 20′ participating in the virtual interaction are related to or otherwise interconnected with the user 21 by virtue of the interactive social network 10, described above.

For illustrative purposes only, a realtor who is trying to sell a home may create a virtual open house via the interactive social network 10 of the present specification wherein various members 20 may participate in active open dialogue with the realtor, themselves, and other members 20′ within their social networks for example by virtue of having one or more affinities or belonging to one another's tiers of the multi-tiered network system 22 described above.

At least one embodiment of the present specification further includes alerting a recipient, such as a member 20, 20′ of the interactive social network 10, upon the occurrence of an event. Specifically, in at least one embodiment, the recipient will receive an alert or notification on their computer, such as the client interface 28, which, as above may include a desktop computer, laptop computer, PDA, cellular telephone, game console, etc. Accordingly, the alert may include, but is in no way limited to, a pop-up display, flashing icon, sound or audio notification, e-mail, text message, Short Messaging Service (“SMS”), instant message, etc. The alert or notification may be transmitted or controlled by the interactive social network 10, via the interactive computer network 40, radio waves, satellite, or other communication medium(s). Further, as will be described below, in at least one embodiment of the present specification, the recipient may manage, control, customize, and/or edit the topics, genres, or specific individuals from which to receive relevant alerts or notifications.

In at least one embodiment, the alert system and method of the present specification includes a plurality of alert types, for example, commerce-related alerts, community-related alerts, and/or emergency-related alerts. The alert or notification sent to the recipient may be immediately distinguishable depending upon the type of alert, for example, by a unique color, sound, flash, etc.

Commerce-related alerts of at least one embodiment are generally related to sales, auctions, or other like events which may occur within the interactive social network 10, or other Internet site(s) 10′, social/electronic commerce network(s), and/or online marketplace(s), such as eBAY®, AMAZON.COM®, MYSPACE®, LINKEDIN®, FACEBOOK®, etc. The recipient has the ability to receive alerts from all stores or members 20, 20′ offering to sell a product or service. However, the recipient may specifically choose to receive alerts pertaining to specific stores, members 20, 20′, or products/services, the content of which has been filtered and is relevant to the recipient's criteria. In particular, for illustrative purposes only, the recipient may identify, for example, by managing their social network account or profile within the interactive social network 10, to receive alerts or notifications pertaining to a seven (7) night cruise to the Caribbean, or a seven (7) night cruise to the Eastern Caribbean with a port of call in St. Thomas, departing Fort Lauderdale, Fla. in January or February. When an authorized individual, such as a store within the interactive social network 10 or a member 20, 20′ of the interactive social network 10, offers for sale a product or service matching the recipient's selected alert criteria, the method of at least one embodiment of the present specification will alert the recipient of such a sale.

Community-related alerts of at least one embodiment of the present specification are generally related to the recipient's network within the interactive social network 10 and the various members 20, 20′ with which the recipient is related to or interconnected with, for example, based upon one or more of the tiers 23, 24, 25 of the multi-tiered network system 22 described above. In particular, the recipient may elect to receive alerts for activity occurring within the interactive social network 10, for example, when a member 20, 20′ posts a network object, such as a comment, review, photograph, video, etc. within one or more of the recipient's network tiers. Furthermore, the community-related alerts may be managed, controlled, and/or customized by the recipient. For example, the recipient may elect to receive alerts pertaining to network objects posted within the recipient's public tier 25 and/or semi-private tier 24. In addition, the recipient may elect to receive alerts pertaining to activity related to a particular member 20, 20′, such as network objects posted by the selected member 20, 20′. Of course, the recipient may mix and match various criteria in order to completely customize their alert system. For illustrative purposes only, the recipient may opt to receive an alert regarding any activity relating to one particular member 20 within the recipient's public tier 25, but not to receive alerts regarding activity from another member 20′ within the public tier 25. The recipient may also opt to receive alerts regarding network objects and/or sales relating to a particular affinity such as the National Football League Group. Furthermore, the recipient may manage the alerts based upon the content of a particular activity, such as a posted network object. For example, the recipient may opt to receive an alert whenever an article or video is posted within the interactive social network 10 or other Internet site(s) 10′ related to the Philadelphia Eagles' head coach conducting a post game interview, for away games only on the date of the game. Accordingly, in at least one embodiment, whenever a member 20, 20′ posts an article, video, photograph, etc. within a public tier 25, the member 20, 20′ is asked to select and/or identify a topic, genre, etc.

Emergency-related alerts of at least one embodiment of the present specification are generally related to emergency situations and enable authorized officials or individuals to inform members 20, 20′ of the interactive social network 10 of situations that are of high importance, impact the community, or need immediate attention. The information provided by the recipient within the recipient's profile or social account within the interactive social network 10 may determine whether the recipient receives an emergency-related alert or not. Such information may include, but is not limited to, the recipient's address, age, gender, affinities, etc. Examples of an emergency-related alert may include, but are certainly not limited to, a fire causing disruptions to traffic, an Amber alert for a missing child or major crime, cancelled schools regarding severe weather or campus crimes, local events, state events, town meetings, client meetings, etc.

Furthermore, the present specification includes dynamically providing or communicating marketing, advertising, or other like information to the user 21 as the user 21 navigates the interactive computer network 40, such as the World Wide Web. Accordingly, at least one embodiment of the present specification includes displaying to the user 21 an affiliated advertising module, wherein the affiliated advertising module is at least partially related to the affiliated network object(s), such as the comment(s), review(s), suggestion(s), opinion(s), note(s), etc. and/or the particular web page 33 or web content 35 the user 21 is simultaneously viewing. The affiliated advertising module may include a virtual coupon, advertisement, etc. or other advertising or marketing scheme, which may comprise various multimedia, photographs, audio, video, and/or text. For example, when a user 21 visits a web page 33 or other web content 35, as above, at least one embodiment of the present specification includes searching for and displaying affiliated object(s) 52 such as comment(s), review(s), opinion(s), etc. related to the web content 35. At least one embodiment further includes searching for and/or displaying at least one affiliated advertising module which may be at least partially related to the affiliated object(s) 52 and/or the web content 35 by virtue of a keyword, phrase, photos, audio, etc. contained therein. As an illustrative example, a user 21 may search for portable mp3 players, which displays a web page selling an APPLE® iPOD®. The affiliated object(s) 52 may include comments, reviews, etc. related to APPLE®, iPODs®, mp3 player in general, etc. Similarly, the affiliated advertising module may include coupons, advertisements, surveys, etc. related to APPLE®, iPODs®, mp3 players, etc. based upon a keyword, phrase, or other item contained within the affiliated object(s) 52 and/or the actually web content 35. Accordingly, by virtue of the affiliated advertising module, at least one embodiment of the present specification includes target marketing based upon keywords or other identifying items.

Furthermore, in at least one embodiment the affiliated advertising module is at least partially related to the interactive social network 10 and/or the various members 20, 20′ the user 21 is interconnected with or related to. For example, at least one embodiment of the present specification includes identifying the user's 21 internal or personal network of members 20, 20′ within the interactive social network 10 and displaying an affiliated advertising module in association therewith. For instance, if the user 21 is interconnected with a member 20 who sells mp3 players, such as an APPLE® store, the present specification may intermittingly, or at pre-designated times display various coupons, surveys, or other affiliated advertising modules related thereto.

In particular, a seller, advertiser, or marketer may, in at least one embodiment, create advertisements, coupons, or other advertising module(s) which may appear as a pop-up display, as a network object, instant message, text message, e-mail, etc., or as an alert as identified above, as the user 21 requests web content 35 or otherwise navigates the World Wide Web. As described above, the coupon(s), advertisement(s), or advertising module(s) may be at least partially related to the web content 35 or the affiliated network object(s) 52. In at least one embodiment, the coupon(s) and/or advertisement(s) are time sensitive and thus may require the recipient to act upon them in a timely manner which may or may not be identified on the coupon, advertisement, or alert.

Moreover, the seller, advertiser, or marketer may establish various thresholds or variables which will at least partially determine when the advertisement(s), coupon(s), or other affiliated advertising module(s) are displayed and to whom they are sent. For example, a seller may opt to send a coupon for a product to every user 21 who visits one or more particular web pages 33. In addition, the seller may opt to send the coupon to every member 20, 20′ related to or otherwise interconnected with the user 21 who visits one or more web pages 33. In yet another embodiment, the seller may opt to send a coupon to the user 21 and all members 20, 20′ who belong to the South Florida Group or members 20, 20′ who view a particular network comment, sale, or other network object.

Furthermore, in at least one embodiment, the coupon, advertisement, or other advertising or marketing module may be sent or transferred to one or more recipients via certified delivery or may include a mandatory or voluntary return-receipt confirmation. As such, the sender, i.e., the marketer, advertiser, or other affiliated entity, is able to track the coupon(s), advertisement(s), etc. and confirm its receipt by the recipient. The data retrieved there from may then be utilized in various manners, including but not limited to deciding whether to send future coupon(s) or advertisement(s), whom to send the coupons or advertisements to, and/or whether the coupon(s) or advertisement(s) is effective or needs adjustments.

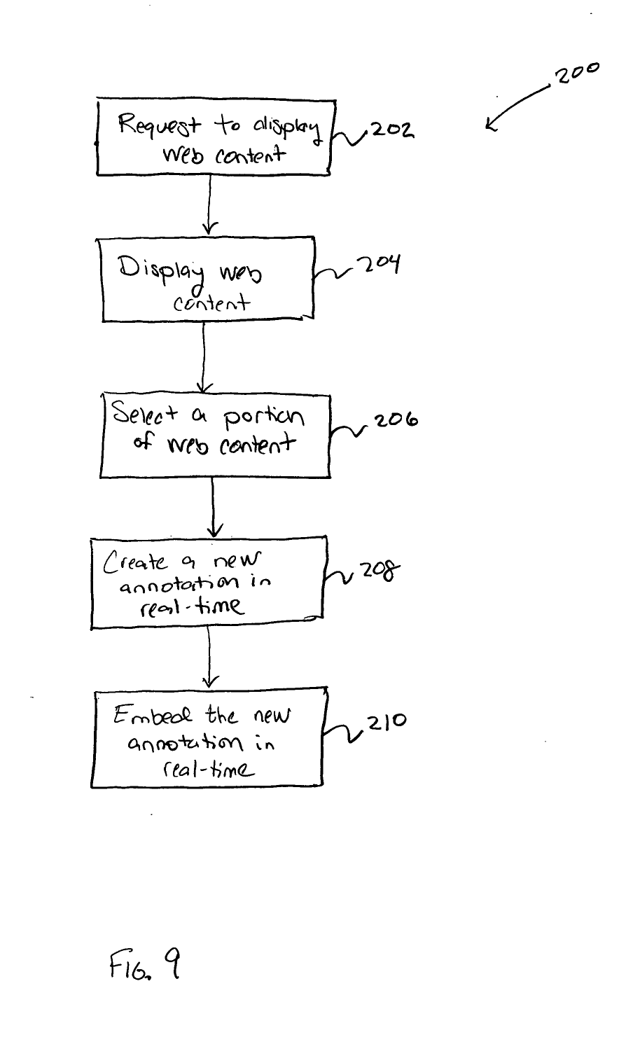

Referring now to FIG. 9, the present specification further includes a computer-related method 200 for dynamically annotating web content in real-time via an interactive computer network. In particular, at least one embodiment of the method 200 includes requesting, by a user via a client interface disposed in a communicative relation with the interactive computer network, to display web content, as indicated at 202. For example, as above, a user 21 or other individual may request web content 35 from a web server 30 by communicating a request 27 which may include a web address or at least one search query via the interactive computer network 40, such as the World Wide Web. In at least one embodiment, the method 200 may be application-based such that the user 21 may download, install, and/or otherwise utilize a web browser 60 or other program or application having the features, functions, and options which facilitate the practice of the present invention in the intended manner as described herein. Particularly, it is contemplated that an existing web browser 60, such as MICROSOFT INTERNET EXPLORER®, MOZILLA FIREFOX®, NETSCAPE NAVIGATOR®, etc., may be configured such as via a plug-in or via subsequent released versions to facilitate the practice of the present method 200 in the intended manner. However, the present method 200 may be web-based such that a particular web page and/or web server is suited to execute the features, functions, and/or options of the present specification. In particular, a web page, such as, for example, USATODAY.com, may include a link, button, icon, option, etc., which, when activated initiates the method 200 and/or facilitates the practice of the present method 200 in the intended manner. Moreover, a search engine, web page, or web-based application may be specifically structured or configured to facilitate the practice of the present invention. For example, a user may visit a specifically structured or configured web page or web-based application and navigate to other web pages, such as an online article, etc., and create annotations in real-time, as will be described below.

Furthermore, in response to the request 27 identified above, the method 200 of at least one embodiment of the present specification includes displaying 204, at the client interface, the at least one web page via the interactive computer network. The web page 33, as used herein, includes a document or other like object that is accessible and/or viewable via the World Wide Web or other interactive computer network(s) 40. In particular, the web page(s) 33 of the various embodiments disclosed herein may include at least one or a plurality of portions 34, such as text, graphics, pictures, movies, videos, sounds, advertisements, etc.

In at least one embodiment of the present specification, the method 200 further includes selecting 206 at least one portion of the at least one displayed web page, creating 208 at least one new annotation in real-time via the client interface, and embedding 210 the at least one new annotation at the selected portion of the at least one displayed web page. In particular, while simultaneously viewing a web page 33 or other web content 35, for example via a web browser 60 as the web page 33 is displayed from the web server 30, a user 21 may desire to highlight or provide one or more comment(s), opinion(s), review(s), remark(s), note(s), or other annotation(s) directed to or otherwise associated with a specific portion 34 of the web page 33 or other web content 35, such as, for example, a particular letter, word, phrase, sentence, paragraph, photograph, video, etc. Accordingly, rather than providing an comment generally related to the web page 33 and placed or embedded at or near the bottom or other pre-designated portion thereof, a user 21 or other individual or entity of at least one embodiment of the method 200 of the present specification selects a portion 34 of the web page 33, by utilizing, for example, the mouse, keyboard, joystick, or other pointing or controlling device. For instance, the user 21 may highlight or select the portion 34 of the web page 33 or web content 35 and/or point to the portion 34 of the web page 33 or web content 35 by dragging or managing an arrow or other like mechanism provided by the method 200 of the present specification, such as via the web browser 60 or other like program or device.

Moreover, the user 21 or other individual may further create at least one new annotation 70 in real-time, wherein the new annotation 70 is embedded within the web page 33 at the selected portion 34 thereof. In particular, as the user 21 is reading or otherwise viewing the content 35 of a web page 33 for example within the web browser 60, without first having to save or download the web content 35, the user 21 may select a portion 34 of the web page 33 and create a new annotation 70 directly thereon. Specifically, the user 21 need not first download the web page 33, save the web page 33, or convert the web page 33 or its contents to another format. Rather, in at least one embodiment, the method 200 of the present specification, creates and/or embeds the new annotation 70 in real-time, as the user 21 views the contents of the web page 33, for example, via a web browser 60.

As such, in at least one embodiment, the new annotation 70 may be embedded or displayed at or near the selected portion 34 of the web page 33 such that the new annotation 70 is always viewable contemporaneously with the web content 35 and/or web page 33. Thus, because a new annotation 70 may include, in at least one embodiment, configuration of text, such as for example, highlighting, underlining, italicizing, bolding, or changing the color of the text, the new annotation 70 may be embedded within the web page 33 such that the new annotation 70 or configured text is visible to a viewer thereof. However, the new annotation 70 may be embedded within the web page 33 such that the new annotation 70 is viewable upon the occurrence of a predetermined event, such as a viewer hovering a mouse over the selected portion 34 or clicking on the portion 34.

As identified above, the annotation 70 may be embedded within a video clip, animation, or other multimedia object disposed on the web page 33 or otherwise included within the web content 35. In such an instance, the user 21 may embed the new annotation 70 at the beginning, end, or anywhere throughout the duration of the multimedia object. For example, the user may pause or otherwise stop the video or other multimedia object and embed the new annotation 70 at a particular frame or a particular portion of a frame within the video or other multimedia object. Accordingly, when the video is played or activated, in at least one embodiment of the present specification, the new annotation 70 will appear at the selected portion and the video will continue to play, unless and until the user 21 or other individual pauses or stops the video. In at least one other embodiment, however, the video or other multimedia object will automatically pause, slow down, or stop at or near the selected portion such that the new annotation(s) 70 embedded therein may be easily viewed.

Additionally, at least one embodiment of the method 200 of the present specification includes saving the new annotation and/or web content to an electronic storage medium. The electronic storage medium includes virtually any structure or device capable of electronically storing data and/or information and may include, but is not limited to, an internal, external, or portable hard drive, CD-ROM, DVD-ROM, flash drive, floppy disk, etc. Accordingly, the user 21 may save the web page 33 and/or the new annotation(s) 70 to an electronic storage medium, such as the user's 21 hard drive on the client interface 28. Thereafter, the user 21 may communicate the web page 33 and/or the new annotation(s) 70 to another individual or entity. The other individual or entity may view the web page 33 and the new annotation(s) 70, and in at least one embodiment add or create their own annotations to the web page 33. This, in essence, creates a working document which may be circulated such that various users 21 or other individuals or entities may add comments or annotations to specific selected or designated portions thereof.

Additionally, in at least one embodiment of the present specification, the user 21 may, but need not, belong to an interactive social network 10, 10′. In such an instance, the method 200 may include disposing the at least one web page 33 and/or the new annotation(s) 70 in an accessible and/or annotating relation to a member 20, 20′ of the interactive social network 10, such as, for example, those members 20, 20′ related to or otherwise interconnected with the user 21 by virtue of any one or more of the various manners described above such that the member(s) 20, 20′ may view, read, analyze, comment on, etc., the web page 33 and/or new annotation(s) 70. As such, the user 21 may associate the at least one web page 33 and/or the new annotation(s) 70 with their social network account, for example, by disposing the web page(s) 33 and/or new annotation(s) 70 with any one or more of the various network tiers 23, 24, 25 of the multi-tiered network system 22. For instance, the method 200 may include communicating and/or saving the at least one new annotation 70 to a network/annotation 50 server via the interactive computer network 40. In particular, the at least one new annotation 70 may be saved at the annotation server(s) 50 such that the user 21 or other members 20, 20′ may access, view, read, or analyze the new annotation(s) 70 at a later time.

The new annotation(s) 70 may be accessed either in conjunction with the web page 33 and/or web content 35 within which it is associated or embedded, or independently there from. For example, the user 21 may desire to review one or more of the new annotation(s) 70 in which he or she created. The new annotation(s) 70 may be reviewed contemporaneously with the web page 33 in which the new annotation(s) 70 is embedded. However, in at least one embodiment of the method 200, the user 21 may, if desired, access the new annotation(s) 70 only, independent from the web page 33 and/or web content 35.

In the instance wherein the new annotation(s) 70 is embedded within a video, animation, or other multimedia object, at least one embodiment of the present specification allows the user 21 or other individual or member 20, 20′ of the interactive social network 10, upon viewing, analyzing, or searching for various annotations, to start viewing the video at a designated interval prior to the portion of the video in which the annotation(s) is embedded. For exemplary purposes only, a user 21 may embed a new annotation 70 within a video at a frame located at 3:32. Upon viewing new annotation(s) 70, at least one embodiment of the present specification allows a user 21 or other individual or member 20, 20′ to begin playing or watching the video at a designated interval prior to the new annotation(s) 70, such as 5, 10, or 15 seconds. This allows a user 21 or other individual or member 20, 20′ to easily locate, find, and review various annotations, such as reviews, opinions, comments, etc. that may be buried within a frame of a video located on the web page 33.

Furthermore, in yet another embodiment of the method 200 of the present specification, the members 20, 20′ of the interactive social network 10, such as those related to or interconnected with the user 21, may create, add, and/or embed their own comments, reviews, opinion, or other annotations 72 within the same web page(s) 33 or web content 35. As such, what was once a static web page 33 displaying various web content 35, such as an article, text, photograph(s), video(s), animation(s), etc., becomes a working document which individuals or members 20, 20′ of the interactive social network 10 may add annotations at specific designated portions 34. The annotation(s) created, posted, or developed by a member of the interactive social network 10 is a network annotation as used herein. In at least one embodiment, the network annotation(s) created by various members 20, 20′ or other individuals may be color coded (a different color for each member 20, 20′ or individual), time stamped, or labeled to indicate who created the various annotations and when each annotation(s) was created or embedded.

Further, yet another embodiment of the method 200 of the present specification includes searching in real-time, for at least one affiliated annotation, wherein the at least one affiliated annotation is at least partially related to a pre-selected affiliated portion of the web page. Particularly, the method 200 of at least one embodiment evaluates and/or identifies the requested web content 35, and searches the network/annotation server(s) 50 for affiliated annotations 74 at least partially related thereto. For instance, another individual, such as, for example, a member 20, 20′ of the interactive social network 10, described above, may have inserted or embedded one or more affiliated annotations 74 within the requested web page 33, or a web page having content related thereto. As such, at least one embodiment of the method 200 includes searching for affiliated annotations 74, which include previously created annotation(s), comments, reviews, etc. which are affiliated with or otherwise at least partially related to the requested web content 35.

Moreover, in at least one embodiment, the method 200 of the present specification includes filtering the affiliated annotations 74 based upon, for example, the network relationship status associated between the user 21 and the author of the affiliated annotation(s) 74. Accordingly, the present method 200 may include determining a network relationship status between the user 21 and the member 20, 20′ of the interactive social network 10 who created the affiliated annotation 74. As indicated above, the network relationship status may be based upon any one or more manners of interconnecting the members 20, 20′ of the interactive social network 10. For example, the various members 20, 20′ of the interactive social network 10 may be interconnected or related to one another via one or more degrees of separation and/or affinities. As such, the method 200 of the present specification includes displaying the affiliated annotation(s) 74 or otherwise embedding the affiliated annotation(s) 74 within designated or pre-selected affiliated portions 34 of the web page(s) 33 if the network relationship status between the user 21 and the author of the affiliated annotation(s) satisfies a network relationship criterion.

In addition, in at least one embodiment, the present specification includes searching for and/or displaying an affiliated advertising module. As identified above, the advertising module may include a coupon, advertisement, survey, or other advertising or marketing scheme or mechanism. Further, the affiliated advertising module of at least one embodiment is at least partially related to the annotation(s) 70, 72, 74 and/or the web content 35 by virtue of a keyword, phrase, photograph, audio, genre, scheme, or other identifying information or data.

For illustrative purposes only, utilizing the method 200 of the present specification, a member 20, 20′ of the interactive social network 10 may embed an annotation within a web page or other web content, such as, for example, an article contained on or within a USATODAY.com web page (hereinafter “USATODAY.com article”). Thereafter, a user 21 who also belongs to the interactive social network 10 may utilize a web browser 60 or other application equipped with the structure and function of the method 200 of the present specification in order to view the same or identical web page 33, such as the USATODAY.com article, identified above. In at least one embodiment, the method 200 may search the network/annotation server(s) 50 or other device which includes various web pages 33 and annotations 70, 72, 74 saved by members 20, 20′ of the interactive social network 10. If authorized by member 20, 20′, the method 200 may search for affiliated annotations 74 which were created by a member 20, 20′ and embedded within the web page 33 requested by the user 21, such as the USATODAY.com article. In at least one embodiment, the method 200 may embed the affiliated annotations created by the member(s) 20, 20′ within a portion of the web page selected by the member 20, 20′ which the affiliated annotation was originally created. Furthermore, the affiliated annotations 74 may be filtered in accordance with a network relationship criteria and/or displayed to the user 21 along with an identification of the member 20, 20′ who created the affiliated annotation and/or an identification of the network relationship status between the user 21 and the member 20, 20′. The user 21 may then create one or more new annotations 70 in real time, as the user 21 views the web page 33 in the web browser 60 or other like structure or device and save such document with the annotation(s), as previously mentioned above.

As yet another illustrative example of at least one embodiment in accordance with the present specification, a user 21 may view or access an article, for example a USATODAY.com article, via a web browser 60 and/or the interactive social network 10. In at least one embodiment, and in conjunction with displaying the web content 35, such as the USATODAY.com article, the present specification is structured to automatically, and in real-time, display various guidance-related content. In particular, the guidance-related content may include, but is not limited to, affiliated network objects 52, as disclosed above, and/or affiliated annotations 74. The affiliated object(s) 52 and/or affiliated annotation(s) 74 may be posted or developed on the web page 33 itself or within the interactive social network 10, and furthermore, the affiliated object(s) 52 and/or affiliated annotation(s) 74 may be posted or developed by a member 20 or non-member of the interactive social network 10.

In particular, the displayed guidance-related content may have been submitted, generated, or posted by a member 20 or non-member of the interactive social network 10. In the event the content was created or posted by a member 20 of the interactive social network 10, such as a first member, the content, i.e., the affiliated object(s) 52 or annotation(s) 70, 72, 74, may have been posted in association with the interactive social network 10, such as, while the member 20 was logged into or otherwise utilizing its social network account and/or by utilizing its interactive social network 10 identification, username, e-mail address, etc. However, the content may have instead been submitted or posted directly on the web page itself, and/or completely independent of the interactive social network 10. For example, a member 20, such as a second member, may submit comments, reviews, opinions, annotations, etc. directly on a web page 33 without being logged into or without utilizing the second member's 20, 20′ social network account associated with the interactive social network 10.

In the situation where a member 20 of the interactive social network 10 posts a comment, review, note, annotation, etc. independent of the interactive social network 10, for example, by not utilizing the member's social network account, at least one embodiment of the present specification is structured and configured to link the review, comment, annotation, etc. to the member's 20 interactive social network 10 account, e-mail address, username, or other identification. For example, in at least one embodiment, the member 20 may indicate to the interactive social network 10 or other associated entity one or more usernames, identifications, e-mail addresses, etc. the member 20 uses on other Internet sites 10′ and/or the interactive computer network 40 to post comments, reviews, annotations, etc. Accordingly, the present specification may include linking the comment, review, or other affiliated network object 52 or affiliated annotation 74 with the member 20 and/or the member's 20 social network account if the affiliated network object 52 or affiliated annotation 74 was posted independent of the interactive social network 10, such as, by the member 20 but not while the member 20 is logged into its social network account with the interactive social network 10.

Accordingly, when the user 21 accesses a web page or other web content 35, such as the USATODAY.com article, the present specification is structured to display and/or sort various comments, reviews, annotations, sales, etc. affiliated with the web content 35, whether posted by a member 20, 20′ or non-member, and whether the comment, review, annotation, etc. was posted in association with or completely independent of the interactive social network 10. For comments, reviews, annotations, etc. posted by a member 20 of the interactive social network 10, at least one embodiment will indicate which members 20 are related to or interconnected with the user 21 within the interactive social network 10, and to what extent, for example, which affinities the member 20 and user 21 share, and/or a degree of separation between the member 20 and the user 21. This allows the user 21 to sort the displayed comments and annotations by a variety of manners, and filter the comments by reliability and/or the user's 21 trust and confidence therein. As such, the user 21 may quickly identify which comments are posted by a member 20 or non-member, and which comments are posted by members 20 interconnected or related to the user 21. In addition, the present specification may automatically sort the various objects, comments, reviews, opinions, annotations, etc. based upon various thresholds or options which may, in at least one embodiment be modified or set by the user 21. In particular, the method may sort based upon the status or association of the comment, review, annotation, etc., such as, for example, whether the comment, review, annotations, etc. was developed by a member 20 or non-member, or whether the member 20 was utilizing its social network account to created or develop the comment, review, annotation, etc. Of course, as above, the comments, reviews, annotations, etc. may be sorted based upon the interconnection or relation within the interactive social network 10, such as affinities, degrees of separation, etc.

In addition, the present method may sort, or allow the user 21 to sort, based upon a rating score or average rating score for the subject matter contained within the comments, reviews, opinions, etc. provided by the member 20 or other entity who created the comments, reviews, opinions, annotations, etc. For example, in the event the subject matter of the various comments or annotations is directed to restaurants in Miami, Fla. the present method may sort the comments, reviews, annotations, etc. based upon the top rated restaurants in Miami, Fla. listing the restaurants with the best rating first. Accordingly, the user 21 may be able to quickly and easily identify which restaurants in Miami, Fla. those members 20 the user 21 is interconnected with or related to within the interactive social network 10 consider to be the best or worst. In addition, the user 21 or method of the present specification may require a minimum number of scores or ratings from a minimum number of member 20 or other entities, e.g. three (3), prior to displaying or sorting based upon the provided score and/or ranking.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A computer-related method for annotating web content in real-time via a client interface, the computer-related method comprising:
requesting, by a user via the client interface disposed in a communicative relation with an interactive computer network, to display web content, the web content including at least one web page,
displaying, at the client interface, the at least one web page via the interactive computer network,
selecting at least one portion of the at least one displayed web page,
creating at least one new annotation in real-time via the client interface, and
embedding, in real-time, the at least one new annotation at the selected portion of the at least one displayed web page.

2. The computer-related method recited in claim 1 further comprising saving the at least one new annotation to at least one electronic storage medium.

3. The computer-related method recited in claim 1 further comprising saving the at least one new annotation and the at least one web page to an electronic storage medium.

4. The computer-related method recited in claim 1 further comprising disposing the at least one web page and the at least one new annotation in an accessible relation to a member of an interactive social network, wherein the user belongs to the interactive social network.

5. The computer-related method recited in claim 4 further comprising associating the at least one web page and the at least one new annotation with a social network account corresponding to the user.

6. The computer-related method recited in claim 2 further comprising communicating the at least one new annotation to an annotation server via the interactive computer network, wherein the annotation server is disposed in a communicative relation with the interactive computer network, the annotation server being associated with the interactive social network.

7. The computer-related method recited in claim 6 further comprising saving the at least one new annotation to the annotation server.

8. The computer-related method recited in claim 7 further comprising saving the at least one web page to the annotation server.

9. The computer-related method recited in claim 4 further comprising viewing the at least one new annotation independently from the at least one web page.

10. The computer-related method recited in claim 4 further comprising viewing the at least one new annotation in conjunction with the at least one web page.

11. The computer-related method recited in claim 4 further comprising disposing the at least one web page and the at least one new annotation in an accessible relation to at least one other member of the interactive social network.

12. The computer-related method recited in claim 11 further comprising creating a working document with the at least one web page.

13. The computer-related method recited in claim 12 further comprising creating at least one network annotation, in real-time by the at least one other member of the interactive social network.

14. The computer-related method recited in claim 13 further comprising embedding the at least one network annotation at a designated portion of the at least one web page.

15. The computer-related method recited in claim 1 further comprising searching, in real-time, for at least one affiliated annotation, wherein the at least one affiliated annotation is at least partially related to the at least one web page.

16. The computer-related method recited in claim 15 further comprising embedding the at least one affiliated annotation within the web page at an affiliated portion thereof, wherein the at least one affiliated annotation is associated with the affiliated portion.

17. The computer-related method recited in claim 15 further comprising displaying, at the client interface, the at least one affiliated annotation.

18. The computer-related method recited in claim 15 further comprising determining a network relationship status associated with the at least one affiliated annotation.

19. The computer-related method recited in claim 18 further comprising, if the network relationship status satisfies at least one network relationship criterion, displaying, at the client interface, the at least one affiliated annotation.

20. The computer-related method recited in claim 18 further comprising, if the network relationship status satisfies a network relationship criterion, embedding the at least one affiliated annotation within the at least one web page at an affiliated portion thereof, wherein the at least one affiliated annotation is associated with the affiliated portion.

21. The computer-related method recited in claim 18 wherein determining the network relationship status associated with the at least one affiliated annotation includes calculating a degree of separation between the user at the client interface and an author of the at least one affiliated annotation, wherein the user and the author belong to an interactive social network.

22. The computer-related method recited in claim 18 wherein determining the network relationship status associated with the at least one affiliated annotation includes identifying at least one affinity associated with the user at the client interface and an author of the at least one affiliated annotation, wherein the user and the author belong to an interactive social network.

23. The computer-related method recited in claim 1 further comprising defining the at least one portion of the at least one web page as including a video.

24. The computer-related method recited in claim 23 further comprising pausing the video, selecting at least one frame of the video, and embedding the annotation within the at least one selected frame of the video.

25. The computer-related method recited in claim 1 further comprising displaying an affiliated advertising module, wherein the affiliated advertising module is at least partially related to the at least one new annotation.

26. The computer-related method recited in claim 1 further comprising displaying an affiliated advertising module, wherein the affiliated advertising module is at least partially related to the web content.

27. A computer-related method for annotating web content in real-time via a client interface, the computer-related method comprising:
requesting, by a user via the client interface disposed in a communicative relation with an interactive computer network, to display web content, the web content including at least one web page, the user belonging to an interactive social network,
displaying, at the client interface, the at least one web page via the interactive computer network,
selecting at least one portion of the at least one displayed web page,
creating at least one new annotation in real-time via the client interface,
embedding, in real-time, the at least one new annotation at the selected portion of the at least one displayed web page, and
disposing the at least one web page and the at least one new annotation in an accessible and annotating relation to at least one member of the interactive social network so as to create a working document.

28. The computer-related method recited in claim 27 further comprising communicating the at least one new annotation to an annotation server via the interactive computer network, the annotation server being associated with the interactive social network.

29. The computer-related method recited in claim 27 further comprising viewing the at least one new annotation independently from the at least one web page.

30. The computer-related method recited in claim 27 further comprising viewing the at least one new annotation in conjunction with the at least one web page.

31. The computer-related method recited in claim 27 further comprising disposing the at least one web page and the at least one annotation in an accessible relation to at least one other member of the interactive social network.

32. The computer-related method recited in claim 31 further comprising creating at least one network annotation, in real-time, by the at least one other member of the interactive social network.

33. The computer-related method recited in claim 32 further comprising embedding the at least one network annotation at a designated portion of the at least one web page.

34. A computer-related method for annotating web content in real-time via an interactive computer network, the computer-related method comprising:
requesting, by a user via a client interface disposed in a communicative relation with the interactive computer network, to display web content, the web content including at least one web page,
searching, in real-time, for at least one affiliated annotation, wherein the at least one affiliated annotation is at least partially related to the web content,
displaying, at the client interface, the at least one web page via the interactive computer network, and
embedding the at least one affiliated annotation within the displayed web page at a pre-selected affiliated portion thereof.

35. The computer-related method recited in claim 34 further comprising determining a network relationship status associated with the user and a member of an interactive social network, wherein the member created the at least one affiliated annotation.

36. The computer-related method recited in claim 35 further comprising, if the network relationship status satisfies a network relationship criterion, embedding the at least one affiliated annotation within the at least one web page at the pre-selected affiliated portion.

37. The computer-related method recited in claim 34 further comprising selecting at least one portion of the at least one displayed web page.

38. The computer-related method recited in claim 37 further comprising creating, at the selected portion, at least one new annotation in real-time via the client interface.

39. The computer-related method recited in claim 38 further comprising embedding the at least one new annotation at the selected portion of the at least one web page.

40. The computer-related method recited in claim 39 further comprising disposing the at least one web page, the at least one new annotation, and the at least one affiliated annotation in an accessible and annotating relation to at least one member of an interactive social network.

41. The computer-related method recited in claim 40 further comprising communicating the at least one new annotation to the annotation server via the interactive computer network so as to create a working document.

42. The computer-related method recited in claim 34 further comprising searching for a plurality of affiliated annotations, a first one of the plurality of affiliated annotations being created by a first member of an interactive social network utilizing a first social network account, a second one of the plurality of affiliated annotations being developed by a second member of the interactive social network independently of the interactive social network.

43. The computer-related method recited in claim 42 further comprising linking the second one of the plurality of affiliated annotations to a second social network account associated with the second member.

44. The computer-related method recited in claim 43 wherein a third one of the plurality of affiliated annotations is developed by a non-member.

45. The computer-related method recited in claim 44 further comprising automatically sorting the plurality of affiliated annotations.
